(19) United States
(12) Patent Application Publication
(10) Pub. No.: US 2024/0330658 A1
(43) Pub. Date: Oct. 3, 2024

(54) METHOD FOR NATURAL LANGUAGE PROCESSING, METHOD OF TRAINING NATURAL LANGUAGE PROCESSING MODEL, AND DEVICE

(71) Applicants: BEIJING BOE TECHNOLOGY DEVELOPMENT CO., LTD., BEIJING (CN); BOE TECHNOLOGY GROUP CO., LTD., BEIJING (CN)

(72) Inventors: Chuqian ZHONG, Beijing (CN); Boran JIANG, Beijing (CN); Ge OU, Beijing (CN); Chao JI, Beijing (CN); Shuqi WEI, Beijing (CN); Mengjun HOU, Beijing (CN)

(73) Assignees: BEIJING BOE TECHNOLOGY DEVELOPMENT CO., LTD., BEIJING (CN); BOE TECHNOLOGY GROUP CO., LTD., BEIJING (CN)

(21) Appl. No.: 18/554,730

(22) PCT Filed: Aug. 17, 2022
(86) PCT No.: PCT/CN2022/112930

§ 371 Date: Oct. 10, 2023

(30) Foreign Application Priority Data
Aug. 18, 2021 (CN) 202110947769.4

(51) Int. Cl. G06N 3/0455; G06N 3/0499

(52) U.S. Cl. CPC G06N 3/0455; G06N 3/0499

(57) ABSTRACT

The present disclosure relates to a method for natural language processing, a method of training a natural language processing model, an electronic device, and a non-transitory computer-readable storage medium, and relates to the technical field of natural language processing. The method for natural language processing includes: acquiring text data; and processing the text data by using a natural language processing model to obtain output information, wherein the natural language processing model comprises a first attention model, the first attention model comprising a sequential coding matrix for adding, on the basis of the text data, sequential relation information between at least one word and other words in the text data.

### CROSS-REFERENCE TO RELATED APPLICATIONS

The present disclosure is a U.S. National Stage Application under 35 U.S.C. § 371 of International Patent Application No. PCT/CN2022/112930, filed on Aug. 17, 2022, which is based on and claims the priority to the Chinese patent application No. 202110947769.4 filed on Aug. 18, 2021, the disclosure of both of which are incorporated herein by reference in its entirety.

### TECHNICAL FIELD

The present disclosure relates to the technical field of natural language processing technology, and in particular, to a method for natural language processing, a method of training a natural language processing model, an electronic device, and a computer-readable storage medium.

### BACKGROUND

Natural language processing (NLP) is an important direction in fields of computer science and artificial intelligence. It studies various theories and methods that enable efficient communication in a natural language between a human and a computer. For example, text data may be processed by using natural language processing technologies.

In the related art, positional encoding is performed on positions of words in text data, and the text data and positional encoding together are inputted into a natural language processing model, to obtain a natural language processing result.

### SUMMARY

According to some embodiments of the present disclosure, there is provided a method for natural language processing, comprising: acquiring text data; and processing the text data by using a natural language processing model to obtain output information, wherein the natural language processing model comprises a first attention model, the first attention model comprising a sequential coding matrix for adding, on the basis of the text data, sequential relation information between at least one word and other words in the text data.

According to some embodiments of the present disclosure, there is provided a method for natural language processing, comprising: acquiring text data; performing word embedding processing on at least one word in the text data to obtain word vector data; processing the word vector data by using a natural language processing model to obtain output information, comprising: performing linear transformation on the word vector data to obtain a first word vector matrix and a second word vector matrix; determining a third word vector matrix according to the first word vector matrix and the second word vector matrix; determining a fourth word vector matrix according to the third word vector matrix and a sequential coding matrix for adding, on the basis of the text data, sequential relation information between the at least one word and other words in the text data; and determining the output information of the natural language processing model according to the fourth word vector matrix.

According to some embodiments of the present disclosure, there is provided a method for natural language processing, comprising: acquiring text data; performing word embedding processing on at least one word in the text data to obtain word vector data; processing the word vector data by using a natural language processing model to obtain output information, comprising: acquiring an association matrix of the word vector data for characterizing incidence relation information between the at least one word and other words in the text data; determining a sequential association matrix according to the association matrix and a sequential coding matrix for adding, on the basis of the text data, sequential relation information between the at least one word and other words in the text data; and determining the output information of the natural language processing model according to the sequential association matrix.

According to some embodiments of the present disclosure, there is provided a method of training a natural language processing model, comprising: acquiring text data; processing the text data by using the natural language processing model to obtain output information, the natural language processing model comprising a first attention model, wherein the first attention model comprises a sequential coding matrix for adding, on the basis of the text data, sequential relation information between at least one word and other words in the text data; and training the natural language processing model according to the output information of the natural language processing model to obtain the trained natural language processing model.

According to some embodiments of the present disclosure, there is provided a method of training a natural language processing model, comprising: acquiring text data; performing word embedding processing on at least one word in the text data to obtain word vector data; processing the word vector data by using the natural language model processing to obtain output information, comprising: performing linear transformation on the word vector data to obtain a first word vector matrix and a second word vector matrix; determining a third word vector matrix according to the first word vector matrix and the second word vector matrix; determining a fourth word vector matrix according to the third word vector matrix and a sequential coding matrix for adding, on the basis of the text data, sequential relation information between the at least one word and other words in the text data; and determining the output information of the natural language processing model according to the fourth word vector matrix; and training the natural language processing model according to the output information of the natural language processing model to obtain the trained natural language processing model.

According to some embodiments of the present disclosure, there is provided a method of training a natural language processing model, comprising: acquiring text data; performing word embedding processing on at least one word in the text data to obtain word vector data; processing the word vector data by using the natural language processing model to obtain output information, comprising: acquiring an association matrix of the word vector data for characterizing incidence relation information between the at least one word and other words in the text data; determining a sequential association matrix according to the association matrix and a sequential coding matrix used for adding, on the basis of the text data, sequential relation information between the at least one word and other words in the text data; and determining the output information of the natural language processing model according to the sequential association matrix; and training the natural language processing model according to the output information of the natural language processing model to obtain the trained natural language processing model.

In some embodiments, the sequential coding matrix is formed by an upper triangular matrix and a lower triangular matrix, the upper triangular matrix is different from the lower triangular matrix, and a value of any element of the sequential coding matrix is not 0.

In some embodiments, a value of any element of the upper triangular matrix is different from a value of any element of the lower triangular matrix.

In some embodiments, the sequential coding matrix meets at least one of: elements of the upper triangular matrix having a same value; or elements of the lower triangular matrix having a same value.

In some embodiments, values of the elements of the upper triangular matrix are opposite numbers to values of the elements of the lower triangular matrix.

In some embodiments, the elements of the upper triangular matrix and the lower triangular matrix have absolute values of 1.

In some embodiments, the value of an element in the sequential coding matrix is a training parameter of the natural language processing model.

In some embodiments, the sequential coding matrix has a same matrix structure as the association matrix.

In some embodiments, the determining a sequential association matrix according to the association matrix and a sequential coding matrix comprises: determining the sequential association matrix according to a product of the association matrix and the sequential coding matrix.

In some embodiments, the determining a fourth word vector matrix according to the third word vector matrix and a sequential by using scale transformation according to the third word vector matrix and the sequential coding matrix.

In some embodiments, the processing the text data by using the natural language processing model to obtain output information comprises: performing word embedding processing on the at least one word in the text data to obtain word vector data; and processing the word vector data by using the natural language processing model to obtain the output information.

In some embodiments, the acquiring an association matrix of the word vector data comprises: performing linear transformation on the word vector data to obtain a first word vector matrix and a second word vector matrix; determining a third word vector matrix according to the first word vector matrix and the second word vector matrix; and determining the association matrix according to the third word vector matrix; and the determining a sequential association matrix according to the association matrix and a sequential coding matrix comprises: determining a fourth word vector matrix according to the third word vector matrix and the sequential coding matrix; and determining the sequential association matrix according to the fourth word vector matrix.

In some embodiments, the determining a fourth word vector matrix according to the third word vector matrix and the sequential by using scale transformation according to the third word vector matrix and the sequential coding matrix.

In some embodiments, the determining the fourth word vector matrix by using scale transformation according to the third word vector matrix and the sequential coding matrix comprises: determining a product of the third word vector matrix and the sequential coding matrix; and determining the fourth word vector matrix by using scale transformation according to the product.

In some embodiments, the determining the fourth word vector matrix by using scale transformation according to the third word vector matrix and the sequential coding matrix comprises: performing scale transformation on the third word vector matrix; and determining the fourth word vector matrix according to a product of the third word vector matrix after the transformation and the sequential coding matrix.

In some embodiments, the determining the output information of the natural language processing model according to the sequential association matrix comprises: sequentially performing alignment operation and normalization operation on the fourth word vector matrix to obtain a first attention score matrix used for describing an attention weight scores of word vectors in the word vector data; and determining the output information of the natural language processing model according to the first attention score matrix.

In some embodiments, the performing linear transformation on the word vector data comprises: performing linear transformation on the word vector data to obtain a fifth word vector matrix; and the determining the output information of the natural language processing model according to the first attention score matrix comprises: determining the output information of the natural language processing model according to a product of the first attention score matrix and the fifth word vector matrix.

In some embodiments, the first word vector matrix and the second word vector matrix in the first attention model are obtained based on different linear transformation of a same word vector; the first word vector matrix and the second word vector matrix in the second attention model are obtained based on different linear transformation of a same word vector; or the first word vector matrix and the second word vector matrix are obtained based on linear transformation of different word vectors, respectively.

In some embodiments, the processing the text data by using the natural language processing model to obtain output information of the natural language processing model comprises: performing word embedding processing on the at least one word in the text data to obtain word vector data; performing, by using the first attention model, the following operation on the word vector data: performing linear transformation on the word vector data to obtain a first word vector matrix and a second word vector matrix corresponding to the text data; determining a third word vector matrix in the first attention model according to the first word vector matrix corresponding to the text data and the second word vector matrix corresponding to the text data; determining a fourth word vector matrix according to the third word vector matrix corresponding to the text data and a sequential coding matrix for adding, on the basis of the text data, sequential relation information between the at least one word and other words in the text data; and determining an output of the first attention model according to the fourth word vector matrix; and determining the output information of the natural language processing model according to the output of the first attention model.

In some embodiments, the natural language processing model further comprises a feedforward neural network, the word vector data is an input to the first attention model, the output of the first attention model is an input of the feedforward neural network.

In some embodiments, the natural language processing model comprises an encoding layer and a decoding layer, the encoding layer comprises the first attention model and the feedforward neural network, an output of the feedforward neural network is an output of the encoding layer, the output of the encoding layer is an input to the decoding layer, an output of the decoding layer is the output information of the natural language processing model.

In some embodiments, the decoding layer comprises a second attention model and a third attention model, an input to the third attention model comprising the output of the encoding layer and an output of the second attention model, an output of the third attention model is the output of the decoding layer.

In some embodiments, the natural language processing model comprises a plurality of the encoding layers connected in series and a plurality of the decoding layers connected in series, an input to a first encoding layer is the word vector data, an output of a last encoding layer is an input to each decoding layer, an output of a last decoding layer is the output information of the natural language processing model.

In some embodiments, the decoding layer comprises a second attention model and a third attention model, the determining the output information of the natural language processing model according to the output of the first attention model comprising: performing linear transformation on an input to the second attention model by using the second attention model to obtain a first word vector matrix and a second word vector matrix in the second attention model; determining a third word vector matrix in the second attention model according to the first word vector matrix and the second word vector matrix in the second attention model; determining an output of the second attention model according to the third word vector matrix in the second attention model; performing linear transformation on the output of the second attention model by using the third attention model to obtain a first word vector matrix in the third attention model; performing linear transformation on the output of the encoding layer to obtain a second word vector matrix in the third attention model; determining a third word vector matrix in the third attention model according to the first word vector matrix and the second word vector matrix in the third attention model; and determining the output information of the natural language processing model according to the third word vector matrix in the third attention model.

In some embodiments, the determining an output of the second attention model according to the third word vector matrix in the second attention model comprises: sequentially performing scale transformation, alignment operation, sequential, masking operation and normalization operation on the third word vector matrix in the second attention model to obtain a second attention score matrix for describing an attention weight score of the input to the second attention model; and determining the output of the second attention model according to the second attention score matrix.

In some embodiments, the determining the output information of the natural language processing model according to the third word vector matrix in the third attention model comprises: sequentially performing scale transformation, alignment operation and normalization operation on the third word vector matrix in the third attention model to obtain a third attention score matrix for describing an attention weight score of the input to the third attention model; and determining the output information of the natural language processing model according to the third attention score matrix.

In some embodiments, the first word vector matrix and the second word vector matrix in the first attention model are obtained based on different linear transformation of a same word vector; the first word vector matrix and the second word vector matrix in the second attention model are obtained based on different linear transformation of a same word vector; and the first word vector matrix and the second word vector matrix in the third attention model are obtained based on linear transformation of different word vectors.

In some embodiments, the decoding layer comprises a neural network model, the output of the encoding layer is an input to the neural network model, an output of the neural network is the output information of the natural language processing model.

In some embodiments, the natural language processing model comprises an encoding layer and a decoding layer, an output of the encoding layer is an input to the decoding layer, the encoding layer comprises the first attention model, the training the natural language processing model according to the output information of the natural language processing model comprises: processing the text data by using the encoding layer to obtain the output of the encoding layer; inputting the output of the encoding layer into the decoding layer to obtain an output of the decoding layer; determining the output information of the natural language processing model according to the output of the decoding layer; determining a loss value of a loss function according to the output information; and training the natural language processing model according to the loss value of the loss function.

In some embodiments, the text data comprises first training text data and second training text data, the natural language processing model comprises an encoding layer and a decoding layer, an output of the encoding layer is an input to the decoding layer, the encoding layer comprising the first attention model, the training the natural language processing model according to the output information of the natural language processing model comprising: processing the first training text data by using the encoding layer to obtain the output of the encoding layer; determining a loss value of a first loss function according to the output of the encoding layer; performing first training on the encoding layer according to the loss value of the first loss function; processing the second training text data by using the encoding layer after the first training to obtain an output of the encoding layer after the first training; inputting the output of the encoding layer after the first training into the decoding layer to obtain the output information of the natural language processing model; determining a loss value of a second loss function according to the output information of the natural language processing model; and in a case where the encoding layer after the first training is frozen, performing second training on the decoding layer according to the loss value of the second loss function.

In some embodiments, the natural language processing model is a model for natural language generation or a model for natural language understanding.

In some embodiments, the output information is at least one of: translation information of the text data, reply information of the text data, classification information of the text data, or incidence relation information between the text data and other reference text data.

According to some embodiments of the present disclosure, there is provided an electronic device, comprising: a memory; and a processor coupled to the memory, the processor being configured to perform, based on instructions stored in the memory, the method according to any of the embodiments of the present disclosure.

According to some embodiments of the present disclosure, there is provided a computer-storable medium having thereon stored computer program instructions which, when executed by a processor, implement the method according to any of the embodiments of the present disclosure.

Other features of the present disclosure and advantages thereof will become apparent the following detailed description of exemplary embodiments thereof, which proceeds with reference to the accompanying drawings.

### BRIEF DESCRIPTION OF THE DRAWINGS

The accompanying drawings, which constitute part of this specification, illustrate the embodiments of the present disclosure and together with the description, serve to explain the principles of the present disclosure.

The present disclosure may be more clearly understood according to the following detailed description with reference to the accompanying drawings, in which:

FIG. 1A is a flow diagram illustrating a method for natural language processing according to some embodiments of the present disclosure;

FIG. 1B is a flow diagram illustrating a method of training a natural language model according to some embodiments of the present disclosure;

FIG. 2A is a schematic diagram illustrating a sequential coding matrix according to some embodiments of the present disclosure;

FIG. 2B is a schematic diagram illustrating a sequential coding matrix according to other embodiments of the present disclosure;

FIG. 2C is a schematic diagram illustrating a sequential coding matrix according to still other embodiments of the present disclosure;

FIG. 2D is a schematic diagram illustrating a sequential coding matrix according to still other embodiments of the present disclosure;

FIG. 3A is a flow diagram illustrating a method for natural language processing according to other embodiments of the present disclosure;

FIG. 3B is a flow diagram illustrating a method for natural language processing according to other embodiments of the present disclosure;

FIG. 4A is a flow diagram illustrating processing word vector data of text data according to some embodiments of the present disclosure;

FIG. 4B is a flow diagram illustrating processing word vector data of text data according to other embodiments of the present disclosure;

FIG. 5 is a schematic diagram illustrating processing word vector data of text data according to some embodiments of the present disclosure;

FIG. 6 is a flow diagram illustrating processing text data by using a natural language processing model according to some embodiments of the present disclosure;

FIG. 7A is a block diagram illustrating a natural language processing model according to some embodiments of the present disclosure;

FIG. 7B is a block diagram illustrating a natural language processing model according to other embodiments of the present disclosure;

FIG. 8 is a flow diagram illustrating determining output information of a natural language processing model according to an output of a first attention model according to some embodiments of the present disclosure;

FIG. 9A is a schematic diagram illustrating an association matrix of text data ABCD according to some embodiments of the present disclosure.

FIG. 9B is a schematic diagram illustrating an association matrix of text data DCBA according to some embodiments of the present disclosure;

FIG. 9C is a schematic diagram illustrating a value vector matrix of text data ABCD according to some embodiments of the present disclosure;

FIG. 9D is a schematic diagram illustrating a value vector matrix of text data DCBA according to some embodiments of the present disclosure;

FIG. 10 is a block diagram illustrating an electronic device according to one embodiment of the present disclosure;

FIG. 11 is a block diagram illustrating a computer system for implementing some embodiments of the present disclosure.

It should be understood that a size of each portion shown in the drawings is not drawn according to an actual scale. Furthermore, identical or similar reference numerals denote identical or similar components.

### DETAILED DESCRIPTION

Various exemplary embodiments of the present disclosure will now be described in detail with reference to the accompanying drawings. The description of the exemplary embodiments is merely illustrative and is in no way intended to limit this disclosure its application or use. The present disclosure may be implemented in many different forms and is not limited to the embodiments described herein. These embodiments are provided so that this disclosure will be thorough and complete, and will fully convey the scope of the present disclosure to those skilled in the art. It should be noted that: the relative arrangement of components and steps set forth in these embodiments should be construed as exemplary only and not as a limitation unless specifically stated otherwise.

All terms (including technical or scientific terms) used in the present disclosure have the same meanings as those understood by one of ordinary skill in the art to which this disclosure belongs unless specifically defined otherwise. It should be further understood that terms defined in such as a universal dictionary, should be interpreted as having meanings consistent with their meanings in the context of the related art, and should not be interpreted in idealized or overly formalized meanings unless expressly so defined herein.

Techniques, methods, and devices known to one of ordinary skill in the related art might not be discussed in detail but are intended to be part of the description where appropriate.

In the related art, positional encoding is different encoding of positions of different words in text data, for example, positional encoding of words in the text data that are located at positions 1, 2, 3, . . . , n, is A, B, C, . . . , M, where n is a positive integer. Although the positional encoding can record word order information to a certain extent, when positions of statements with a same expression structure are changed in different sentences, positional encoding thereof is also changed, resulting in a problem in accuracy of semantic understanding.

In view of the above technical problem, the present disclosure provides a method for natural language processing and a method of training a natural language processing model, capable of improving accuracy of natural language processing.

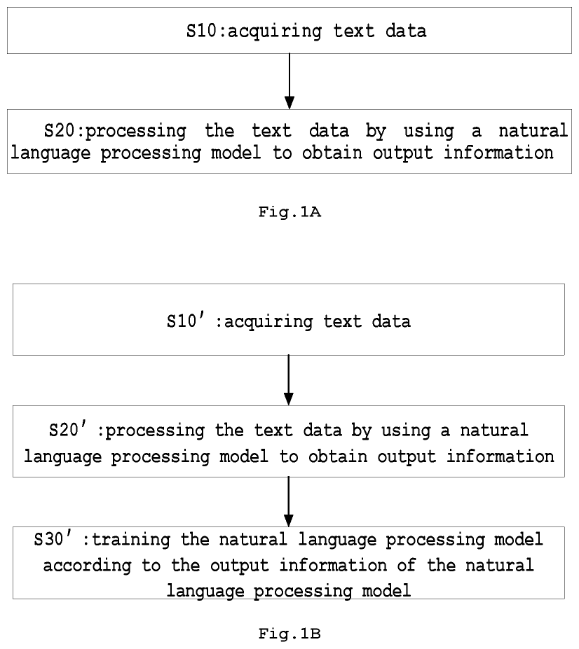

FIG. 1A is a flow diagram illustrating a method for natural language processing according to some embodiments of the present disclosure.

As shown in FIG. 1A, the method for natural language processing comprises: step S10, acquiring text data; and step S20, processing the text data by using a natural language processing model to obtain output information. In the step S10, the text data is taken as text to be processed.

FIG. 1B is a flow diagram illustrating a method of training a natural language model according to some embodiments of the present disclosure.

As shown in FIG. 1B, the method of training a natural language model comprises step S10′, acquiring text data; step S20′, processing the text data by using a natural language processing model to obtain output information; and step S30′, training the natural language processing model according to the output information of the natural language processing model to obtain the trained natural language processing model. In the step S10′, the text data is taken as training text.

The above natural language processing model comprises a first attention model. The first attention model comprises a sequential coding matrix. The sequential coding matrix is used for adding, on the basis of the text data, sequential relation information between at least one word and other words in the text data. It can be determined according to the sequential relation information, for a certain word, which words follow the word and which words precede the word. In some embodiments, for one word, a word located before a position of the word may be encoded as a, while a word located after the position of the word may be encoded as b, to distinguish which words are located before the word and which words are located after the word. For example, the first attention model may be a multi-head attention model. In the above embodiment, by adding the sequential coding matrix in the first attention model of the natural language processing model, the sequential relation information between at least one word and other words in the text data can, on the basis of the text data, be added in a simpler and more convenient form, thereby enabling the natural language processing model to learn word order information of the text data more conveniently and quickly, to understand semantic information of the text data more conveniently and quickly, so that accuracy and efficiency of natural language processing are improved.

In some embodiments, the natural language processing model is a natural language generation-class model or a natural language understanding-class model. The output information is at least one of: translation information of the text data, reply information of the text data, classification information (e.g., emotion classification, etc.) of the text data, or incidence relation information between the text data and other reference text data. For example, the first attention model described above may be applied to a network structure including an attention mechanism, such as Transformer and Bert.

In some embodiments, the sequential coding matrix consists of an upper triangular matrix and a lower triangular matrix. The upper triangular matrix is different from the lower triangular matrix, and a value of any element of the sequential coding matrix is not 0.

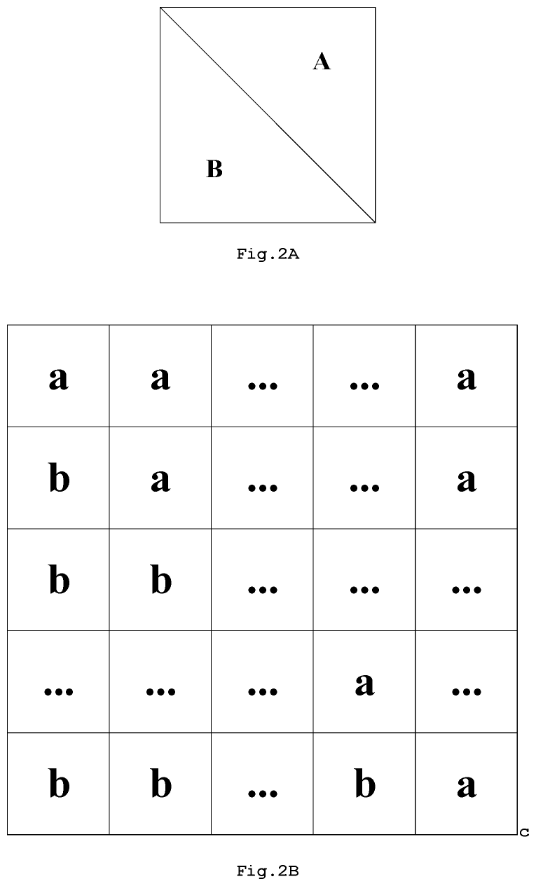

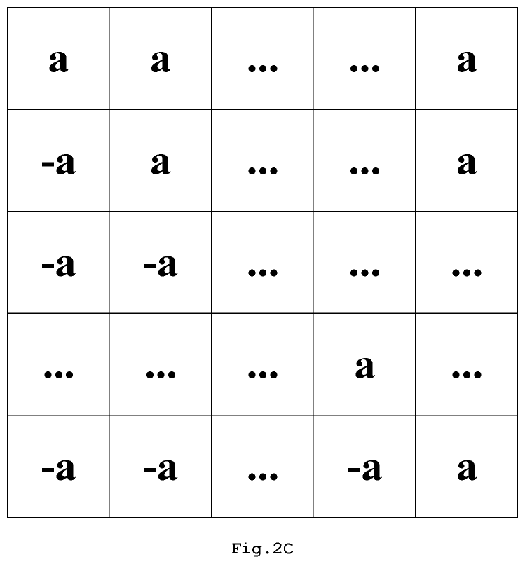

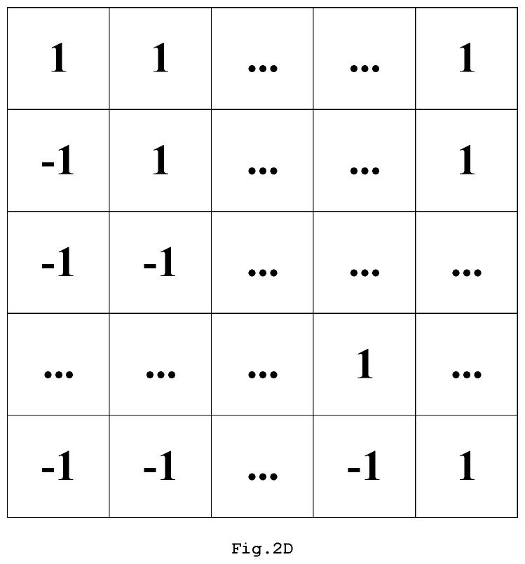

FIG. 2A is a schematic diagram illustrating a sequential coding matrix according to some embodiments of the present disclosure.

As shown in FIG. 2A, the sequential coding matrix comprises an upper right triangular matrix A and a lower left triangular matrix B. The upper right triangular matrix A is different from the lower left triangular matrix B, and a value of any element is not 0.

In some embodiments, the sequential coding matrix may further comprise an upper left triangular matrix and a lower right triangular matrix. It should be appreciated by those skilled in the art that a matrix structure of the sequential coding matrix may be changed by matrix transpose operation for adaptive calculations.

In some embodiments, value of any element of the upper triangular matrix is different from value of any element of the lower triangular matrix.

In some embodiments, the sequential coding matrix meets at least one of: elements of the upper triangular matrix having a same value; or the elements of the lower triangular matrix having a same value. For example, the values of the elements of the upper triangular matrix are the same, and the values of the elements of the lower triangular matrix are the same.

The upper triangular matrix and the lower triangular matrix are respectively provided with the same value of element to hide distance information between words while retaining the order between the words, so that in the process of training the natural language processing model and the process of performing natural language processing by using the natural language processing model, while word order is added, it is ensured that when positions of statements with a same expression structure are changed in different sentences, semantic understanding thereof is unchanged, thereby ensuring semantic flexibility.

In addition, the upper triangular matrix and the lower triangular matrix are respectively provided with the same values of the elements, which not only can hide the distance information between words, to reduce training pressure and improve training efficiency, but also can further improve accuracy and efficiency of the natural language processing.

FIG. 2B is a schematic diagram illustrating a sequential coding matrix according to other embodiments of the present disclosure.

As shown in FIG. 2B, value of elements of an upper right triangular matrix of the sequential coding matrix are all a, and value of elements of a lower left triangular matrix all are b. Neither a nor b is 0. It should be understood that FIG. 2B is only an example, and the sequential coding matrix may also be a matrix in which one triangular matrix has values of elements that are the same, and the other triangular matrix has values of elements that are not completely the same or completely different.

In some embodiments, values of the elements of the upper triangular matrix is opposite number to values of the elements of the lower triangular matrix.

FIG. 2C is a schematic diagram illustrating a sequential coding matrix according to still other embodiments of the present disclosure.

As shown in FIG. 2C, a value of an element of an upper right triangular matrix of the sequential coding matrix is a, and a value of an element of a lower left triangular matrix is −a. For example, a value of an element the upper right triangular matrix of the sequential coding matrix is −a, and a value of an element of the lower left triangular matrix is a. a is not 0. A value of an element on a diagonal of the sequential coding matrix may be a or −a.

In some embodiments, the elements of the upper triangular matrix and the lower triangular matrix have absolute values of 1.

FIG. 2D is a schematic diagram illustrating a sequential coding matrix according to still other embodiments of the present disclosure.

As shown in FIG. 2D, values of elements of an upper right triangular matrix of the sequential coding matrix are 1, and values of elements of a lower left triangular matrix are −1. For example, values of elements of the upper right triangular matrix of the sequential coding matrix are −1, and values of elements of the lower left triangular matrix are 1. A value of element on the diagonal of the sequential coding matrix may be 1 or −1.

In some embodiments, values of elements in the sequential coding matrix may be training parameters of the natural language processing model, or may be preset fixed values.

In a case where the values of elements of the sequential coding matrix are used as the training parameters of the natural language processing model, the sequential coding matrix may be trained in the process of training the natural language processing model, which enables the sequential coding matrix to more accurately characterize word order of the text data, and more flexibly learn distance information between words, so that the natural language processing model can more accurately learn word order information of the text data by using the trained sequential coding matrix, to more accurately and flexibly understand semantic information of the text data, thereby further improving accuracy of natural language processing.

The descriptions of the matrix structure and the values of elements of the sequential coding matrix involved in the above embodiments are all applicable to any embodiment of the present disclosure, and will not be repeated in subsequent embodiments.

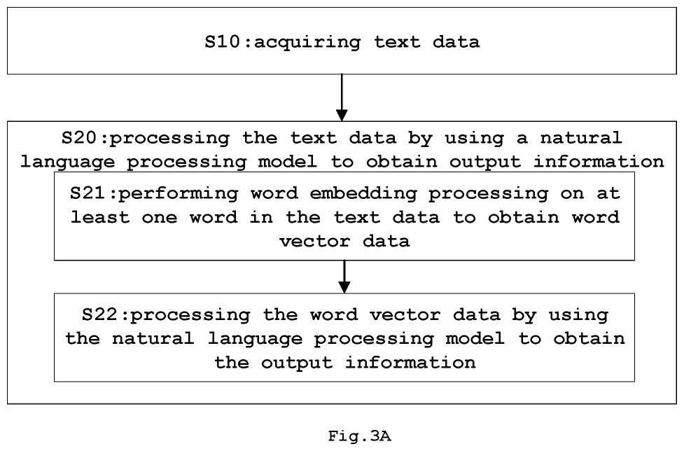

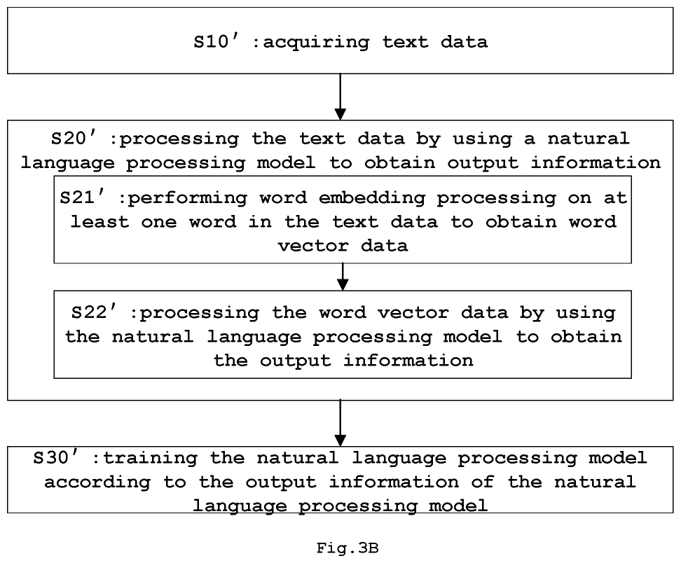

FIG. 3A is a flow diagram illustrating a method for natural language processing according to other embodiments of the present disclosure.

As shown in FIG. 3A, the method for natural language processing comprises: step S10, acquiring text data; and step S20, processing the text data by using a natural language processing model to obtain output information. The output information is output information of the natural language processing model. In the step S10, the text data is taken as data to be processed, for the natural language processing.

FIG. 3B is a flow diagram illustrating a method for natural language processing according to other embodiments of the present disclosure.

As shown in FIG. 3B, the method for natural language processing comprises: step S10′, acquiring text data; step S20′, processing the text data by using a natural language processing model to obtain output information; and step S30′, training the natural language processing model according to the output information of the natural language processing model to obtain the trained natural language processing model. The output information is output information of the natural language processing model. In the step S10′, the text data is taken as training data, for a training process of the natural language processing model.

In some embodiments, as shown in FIGS. 3A and 3B, the processing the text data by using a natural language processing model to obtain output information is implemented by steps S21 and S22 shown in FIG. 3A or by steps S21′ and S22′ shown in FIG. 3B.

In the step S21 or step S21′, word embedding processing is performed on at least one word in the text data to obtain word vector data. In some embodiments, each word in the text data is a minimum unit into which each sentence is split after word segmentation. For example, for Chinese text, word segmentation may be performed according to a phrase, or according to a Chinese character. Taking Chinese text “an apple is red ( [symbol] )” as an example, words may include “an apple ( [symbol] )”, “is ( [symbol] )”, “red ( [symbol] )”. The words “an apple ( [symbol] )” and “red ( [symbol] )” are Chinese phrases, and the word “is ( [symbol] )” is a Chinese character. For another example, for English text, word segmentation may be performed according to an English word, or according to a root. Taking English text “I like biology” as an example, words may include “I”, “like”, “bio”, and the like. The words “I” and “like” are words, and the word “bio” is a root.

In some embodiments, word embedding processing may be performed on the at least one word in the text data by using at least one of a one-hot encoding technique or a word2vec (word to vector) model.

In some embodiments, one-hot encoding is performed on the at least one word in the text data to obtain a one-hot encoding vector. The word vector data is determined according to the one-hot encoding vector.

For example, the one-hot encoding vector may be directly inputted into the natural language processing model.

For another example, after the one-hot encoding vector is multiplied by a trainable weight, it may be inputted into the natural language processing model. The weight may be trained in the natural language processing model or in the word2vec model. In a case where the weight is trained in the word2vec model, the word2vec model may be trained together in the process of training the natural language processing model, or the word2vec model may be frozen to only train the natural language processing model. Assuming that the one-hot encoding vector is X (a size of X is N×V) and the trainable weight is W (a size of W is V×M), the word vector data is Y=X×W (a size of Y is N×M).

In the step S22 or step S22′, the word vector data is processed by using the natural language processing model to obtain the output information.

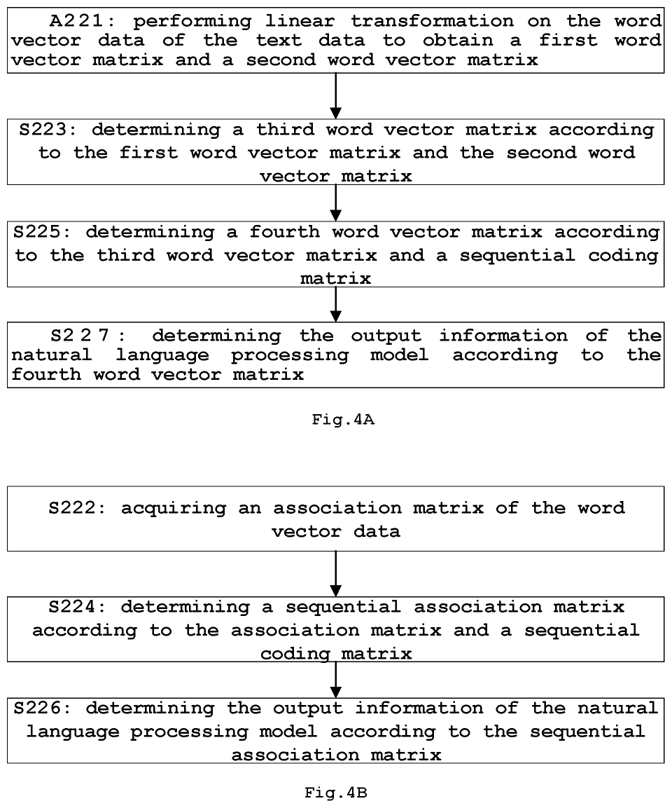

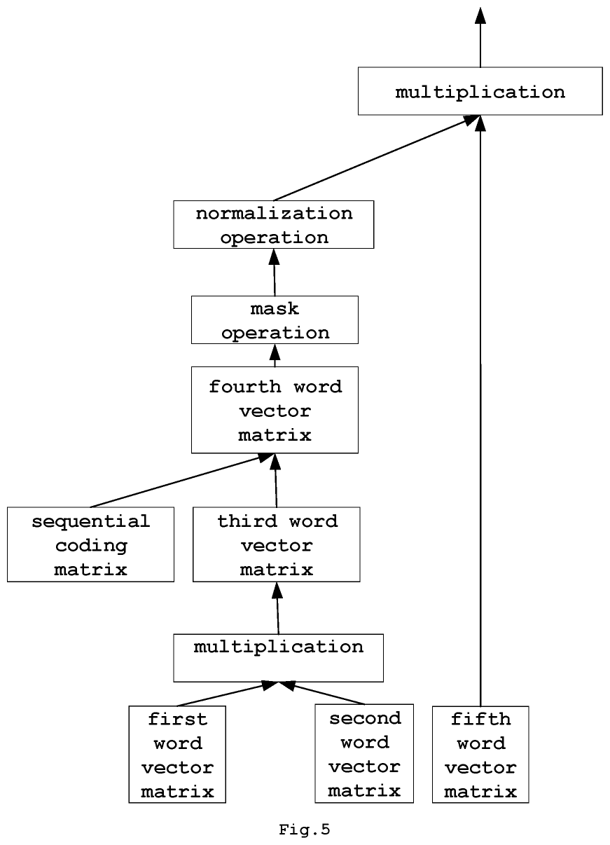

The above step “processing the word vector data by using the natural language processing model to obtain the output information” will be described in detail below in conjunction with FIGS. 4A, 4B, and 5.

FIG. 4A is a flow diagram illustrating processing word vector data of text data according to some embodiments of the present disclosure.

FIG. 4B is a flow diagram illustrating processing word vector data of text data according to other embodiments of the present disclosure.

FIG. 5 is a schematic diagram illustrating processing word vector data of text data according to some embodiments of the present disclosure.

For example, the above step “processing the word vector data by using the natural language processing model to obtain the output information” can be implemented in a manner shown in FIG. 4A.

As shown in FIG. 4A, the processing word vector data of text data comprises steps S221 to S227.

In the step S221, linear transformation on the word vector data of the text data is performed to obtain a first word vector matrix and a second word vector matrix. For example, linear transformation on the word vector data of the text data may be performed one or more times. In some embodiments, the first word vector matrix is a query (q) vector matrix, and the second word vector matrix is a key (k) vector matrix. For example, neither the first word vector matrix nor the second word vector matrix contains positional encoding. In some embodiments, by performing linear transformation on the word vector data of the text data, a value (v) vector matrix may also be obtained.

In some embodiments, the first word vector matrix and the second word vector matrix are obtained based on different linear transformation of a same word vector. In this case, the natural language processing model employs a self-attention mechanism. For example, if an input to a self-attention model is X, the query vector matrix q=X×W^{q}, the key vector matrix k=X×W^{k}, the value vector matrix v=X×W^{v}, where W^{q}, W^{k}, and We are all weight matrices. In some embodiments, the weight matrices may all be trained as training parameters.

In other embodiments, the first word vector matrix and the second word vector matrix are respectively obtained based on linear transformation of different word vectors. In this case, the natural language processing model employs an attention mechanism. Those skilled in the art should appreciate that the self-attention mechanism is a variation of the attention mechanism. For example, if an input to an encoding layer of the attention model is X and an input to a decoding layer is Y, the query vector matrix q=Y×W^{q}, the key vector matrix k=X×W^{k}, the value vector matrix v=X×W^{v}, where W^{q}, W^{k}, and W^{v} are all weight matrices. In some embodiments, the weight matrices may all be trained as training parameters.

In the step S223, a third word vector matrix is determined according to the first word vector matrix and the second word vector matrix. In some embodiments, the third word vector matrix may be determined according to a product between the first word vector matrix and a transpose of the second word vector matrix. Taking an example that the first word vector matrix is the query vector matrix and the second word vector matrix is the key vector matrix, the third word vector matrix is determined according to a product between the query vector matrix and a transpose of the key vector matrix.

For example, as shown in FIG. 5, the third word vector matrix is obtained by performing multiplication between the first word vector matrix and the second word vector matrix using a MatMul function. The MatMul function is used for matrix multiplication.

In the step S225, a fourth word vector matrix is determined according to the third word vector matrix and a sequential coding matrix. As shown in FIG. 5, the fourth word vector matrix may be determined according to the third word vector matrix and the sequential coding matrix. The sequential coding matrix is used for adding, on the basis of the text data, sequential relation information between the at least one word and other words in the text data. For example, the sequential coding matrix is used for adding, on the basis of the third word vector matrix, the sequential relation information between the at least one word and other words in the text data.

In some embodiments, the fourth word vector matrix may be determined by using scale transformation according to the third word vector matrix and the sequential coding matrix.

In some embodiments, a product of the third word vector matrix and the sequential coding matrix is determined, and according to the determined product between the third word vector matrix and the sequential coding matrix, the fourth word vector matrix is determined by using scale transformation. In some embodiments, scale transformation may be performed on the product between the third word vector matrix and the sequential coding matrix to obtain the fourth word vector matrix. For example, the fourth word vector matrix is obtained by performing, after performing multiplication operation on the third word vector matrix and the sequential coding matrix by using a Mul function, scale transformation on the product obtained by the multiplication operation. The Mul function is used for multiplication of positions corresponding to matrix elements. The scale transformation is to divide the third word vector matrix by \sqrt{dₖ}, where dₖ is a word embedding dimension.

In other embodiments, the fourth word vector matrix may also, after scale transformation on the third word vector matrix is performed, be determined according to a product of the third word vector matrix after the transformation and the sequential coding matrix. For example, the fourth word vector matrix is obtained by performing multiplication operation on the third word vector matrix after the transformation and the sequential coding matrix by using the Mul function. For example, the scale transformation is to divide the third word vector matrix by \sqrt{dₖ}, where dₖ is a word embedding dimension.

In the step S227, the output information of the natural language processing model is determined according to the fourth word vector matrix. In some embodiments, the fifth word vector matrix may also be obtained by performing linear transformation on the word vector data of the text data. For example, the fifth word vector matrix is a value (v) vector matrix.

For example, the output information of the natural language processing model is determined according to the fourth word vector matrix and the fifth word vector matrix.

In some embodiments, as shown in FIG. 5, after the fourth word vector matrix is subjected to mask operation processing, normalization operation (e.g., softmax normalization operation) is performed on the result of the mask processing. Finally, multiplication operation is performed on the result (such as a first attention score matrix) of the normalization operation and the fifth word vector matrix by using a MatMul function, to obtain an output of a first attention model of the natural language processing model. According to the output of the first attention model, the output information of the natural language processing model may be determined.

For another example, the above step “processing the word vector data by using the natural language processing model to obtain the output information” may also be implemented in a manner shown in FIG. 4B.

As shown in FIG. 4B, the processing word vector data of text data comprises steps S222 to S226.

In the step S222, an association matrix of the word vector data is acquired. The association matrix is used for characterizing incidence relation information between the at least one word and other words in the text data. For example, the incidence relation information characterizes a weight incidence relation between the at least one word and other words in the text data.

For example, the acquiring an association matrix of the word vector data is implemented in the following manner.

Firstly, linear transformation on the word vector data of the text data is performed to obtain a first word vector matrix and a second word vector matrix. For example, linear transformation on the word vector data of the text data may be performed one or more times. In some embodiments, the first word vector matrix is a query (q) vector matrix, and the second word vector matrix is a key (k) vector matrix. For example, neither the first word vector matrix nor the second word vector matrix contains positional encoding.

In some embodiments, the first word vector matrix and the second word vector matrix are obtained based on different linear transformation of a same word vector. In this case, the natural language processing model employs a self-attention mechanism. In other embodiments, the first word vector matrix and the second word vector matrix are respectively obtained based on linear transformation of different word vectors. In this case, the natural language processing model employs an attention mechanism. Those skilled in the art should appreciate that the self-attention mechanism is a variation of the attention mechanism.

Then, a third word vector matrix is determined according to the first word vector matrix and the second word vector matrix. In some embodiments, the third word vector matrix may be determined according to a product between the first word vector matrix and a transpose of the second word vector matrix. Taking an example that the first word vector matrix is the query vector matrix and the second word vector matrix is the key vector matrix, the third word vector matrix is determined according to a product between the query vector matrix and a transpose of the key vector matrix.

For example, as shown in FIG. 5, the third word vector matrix is obtained by performing multiplication operation on the first word vector matrix and the second word vector matrix by using a MatMul function. The MatMul function is used for matrix multiplication.

Finally, the association matrix is determined according to the third word vector matrix. For example, the association matrix is the third word vector matrix.

In the step S224, a sequential association matrix is determined according to the association matrix and a sequential coding matrix. The sequential coding matrix is used for adding, on the basis of the text data, sequential relation information between the at least one word and other words in the text data. For example, the sequential coding matrix is used for adding, on the basis of the association matrix, the sequential relation information between the at least one word and other words in the text data.

In some embodiments, the sequential coding matrix has a same matrix structure as the association matrix.

In some embodiments, the sequential association matrix is determined according to a product of the association matrix and the sequential coding matrix.

In other embodiments, taking an example of determining the association matrix according to the third word vector matrix, the determining a sequential association matrix according to the association matrix and a sequential coding matrix may be implemented in the following manner.

Firstly, a fourth word vector matrix is determined according to the third word vector matrix and the sequential coding matrix. In some embodiments, the fourth word vector matrix is determined by using scale transformation according to the third word vector matrix and the sequential coding matrix. For example, the sequential coding matrix is used for adding, on the basis of the third word vector matrix, sequential relation information between the at least one word and other words in the text data.

In some embodiments, the fourth word vector matrix may be determined by using scale transformation according to the third word vector matrix and the sequential coding matrix.

In some embodiments, a product of the third word vector matrix and the sequential coding matrix is determined, and according to the determined product, the fourth word vector matrix is determined by using scale transformation. For example, the fourth word vector matrix is obtained by performing, after performing multiplication operation on the third word vector matrix and the sequential coding matrix by using a Mul function, scale transformation on a product obtained by the multiplication operation. The Mul function is used for multiplication of positions corresponding to matrix elements.

In other embodiments, the fourth word vector matrix may also, after scale transformation on the third word vector matrix is performed, be determined according to a product of the third word vector matrix after the transformation and the sequential coding matrix. For example, the fourth word vector matrix is obtained by performing multiplication operation on the third word vector matrix after the transformation and the sequential coding matrix by using a Mul function. For example, the scale transformation is to divide the third word vector matrix by \sqrt{dₖ}, where dₖ is a word embedding dimension.

Then, the sequential association matrix is determined according to the fourth word vector matrix. For example, the sequential association matrix is determined as the fourth word vector matrix.

In the step S226, the output information of the natural language processing model is determined according to the sequential association matrix.

In some embodiments, taking an example of determining the sequential association matrix according to the fourth word vector matrix, the determining the output information of the natural language processing model according to the sequential association matrix may be implemented in the following manner.

Firstly, alignment operation and normalization operation are sequentially performed on the fourth word vector matrix to obtain a first attention score matrix. The first attention score matrix is used for describing an attention weight score for each word vector in the word vector data.

In some embodiments, as shown in FIG. 5, after mask processing is performed on the fourth word vector matrix, normalization operation (e.g., softmax normalization operation) is performed on the result of the mask processing. Finally, multiplication operation is performed on the result of the normalization operation and a fifth word vector matrix by using a MatMul function. The result of performing multiplication operation on the result of the normalization operation and the fifth word vector matrix by using the MatMul function is taken as the first attention score matrix, namely an output of the first attention model of the natural language processing model. The MatMul function is used for matrix multiplication.

Secondly, the output information of the natural language processing model is determined according to the first attention score matrix. Taking an example that the fifth word vector matrix may also be obtained by performing linear transformation on the word vector data of the text data, the output information of the natural language processing model may be determined according to a product of the first attention score matrix and the fifth word vector matrix. For example, the fifth word vector matrix is a value vector matrix.

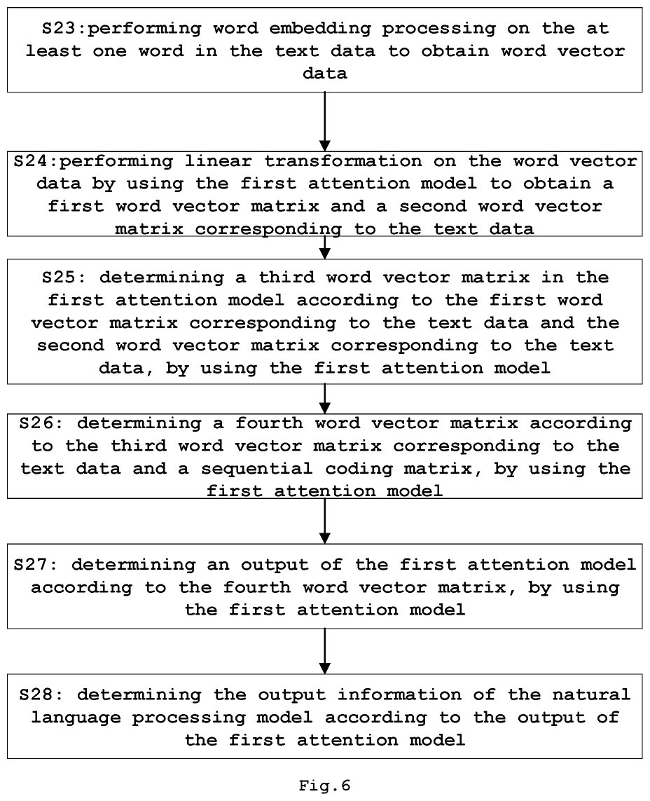

The process of the step “processing the text data by using a natural language processing model to obtain output information” will be described in detail below with reference to FIGS. 5 and 6 from a perspective of a relation between the word vector and the first attention model.

In some embodiments, the step S20 shown in FIG. 3A and the step S20′ shown in FIG. 3B, namely, “processing the text data by using a natural language processing model to obtain output information”, may also be implemented by steps S23 to S28 as shown in FIG. 6.

FIG. 6 is a flow diagram illustrating processing text data by using a natural language processing model according to some embodiments of the present disclosure.

As shown in FIG. 6, the processing text data by using a natural language processing model comprises the steps S23 to S28.

In the step S23, word embedding processing is performed on the at least one word in the text data to obtain word vector data. In some embodiments, each word in the text data is a minimum unit into which each sentence is split after word segmentation. For example, for Chinese text, word segmentation may be performed according to a phrase, or according to a Chinese character. Taking Chinese text “an apple is red ( [symbol] )” as an example, words may include “an apple ( [symbol] )”, “is ( [symbol] )”, “red ( [symbol] )”. The words “an apple ( [symbol] )” and “red ( [symbol] )” are Chinese phrases, and the word “is ( [symbol] )” is a Chinese character. For another example, for English text, word segmentation may be performed according to an English word, or according to a root. Taking English text “I like biology” as an example, words may include “I”, “like”, “bio”, and the like. The words “I” and “like” are words, and the word “bio” is a root.

In the step S24, linear transformation is performed on the word vector data by using the first attention model to obtain a first word vector matrix and a second word vector matrix corresponding to the text data. For example, linear transformation on the word vector data of the text data may be performed one or more times. In some embodiments, the first word vector matrix is a query (q) vector matrix, and the second word vector matrix is a key (k) vector matrix. For example, neither the first word vector matrix nor the second word vector matrix contains positional encoding.

In some embodiments, the first word vector matrix and the second word vector matrix are obtained based on different linear transformation of a same word vector. In this case, the natural language processing model employs a self-attention mechanism. In other embodiments, the first word vector matrix and the second word vector matrix are respectively obtained based on linear transformation of different word vectors. In this case, the natural language processing model employs an attention mechanism. Those skilled in the art should appreciate that the self-attention mechanism is a variation of the attention mechanism.

In the step S25, a third word vector matrix in the first attention model is determined according to the first word vector matrix corresponding to the text data and the second word vector matrix corresponding to the text data, by using the first attention model. Taking an example that the first word vector matrix is the query vector matrix and the second word vector matrix is the key vector matrix, the third word vector matrix is determined according to a product between the query vector matrix and a transpose of the key vector matrix.

For example, as shown in FIG. 5, the third word vector matrix is obtained by performing multiplication operation on the first word vector matrix and the second word vector matrix by using a MatMul function.

In the step S26, a fourth word vector matrix is determined according to the third word vector matrix corresponding to the text data and a sequential coding matrix, by using the first attention model. The sequential coding matrix is used for adding, on the basis of the text data, sequential relation information between the at least one word and other words in the text data. For example, the sequential coding matrix is used for adding, on the basis of the third word vector matrix, the sequential relation information between the at least one word and other words in the text data.

In some embodiments, the fourth word vector matrix may be determined by using scale transformation according to the third word vector matrix and the sequential coding matrix.

In some embodiments, a product of the third word vector matrix and the sequential coding matrix is determined, and according to the product, the fourth word vector matrix is determined by using scale transformation. In some embodiments, scale transformation may be performed on the product between the third word vector matrix and the sequential coding matrix to obtain the fourth word vector matrix. For example, the fourth word vector matrix is obtained by performing, after performing multiplication operation on the third word vector matrix and the sequential coding matrix by using a Mul function, scale transformation on a product obtained by the multiplication operation. The Mul function is used for multiplication of positions corresponding to matrix elements.

In other embodiments, the fourth word vector matrix may also, after scale transformation on the third word vector matrix is performed, be determined according to a product of the third word vector matrix after the transformation and the sequential coding matrix. For example, the fourth word vector matrix is obtained by performing multiplication operation on the third word vector matrix after the transformation and the sequential coding matrix by using the Mul function. For example, the scale transformation is to divide the third word vector matrix by \sqrt{dₖ}, where dₖ is a word embedding dimension.

In the step S27, an output of the first attention model is determined according to the fourth word vector matrix by using the first attention model. In some embodiments, a fifth word vector matrix may also be obtained by linear transformation on the word vector data of the text data. For example, the fifth word vector matrix is a value (v) vector matrix.

For example, the output of the first attention model is determined according to the fourth word vector matrix and the fifth word vector matrix. In some embodiments, as shown in FIG. 5, after mask processing is performed on the fourth word vector matrix, normalization operation is performed on the result of the mask processing. Finally, multiplication operation is performed on the result of the normalization operation and the fifth word vector matrix by using a MatMul function. The result of performing multiplication operation on the result of the normalization operation and the fifth word vector matrix by using the MatMul function is taken as the output of the first attention model of the natural language processing model. The MatMul function is used for matrix multiplication.

In the step S28, the output information of the natural language processing model is determined according to the output of the first attention model.

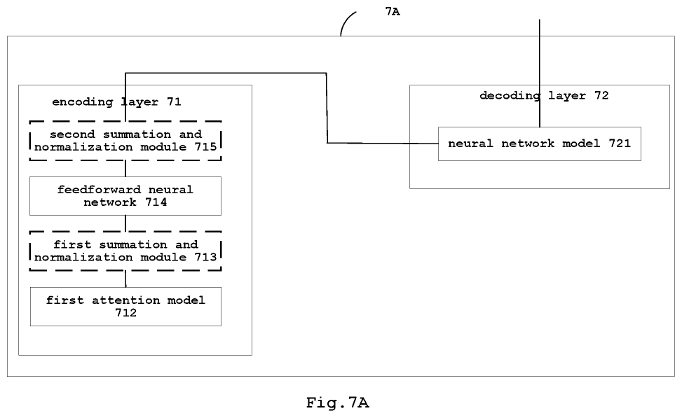

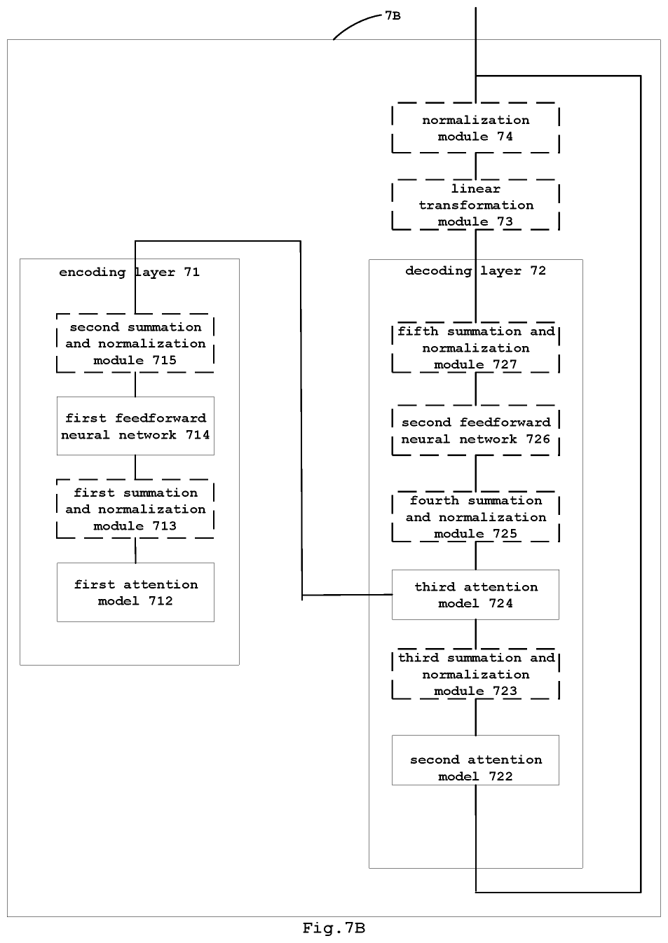

To assist understanding of the above step S28, a model structure of the natural language processing model will be described in detail below in conjunction with FIGS. 7A and 7B.

FIG. 7A is a block diagram illustrating a natural language processing model according to some embodiments of the present disclosure.

As shown in FIG. 7A, a natural language processing model 7A comprises an encoding layer 71, the encoding layer 71 comprising a first attention model 712. The first attention model 712 performs the steps S24 to S27 as shown in FIG. 6.

In some embodiments, the encoding layer 71 further comprises a feedforward neural network 714. The word vector data of the text data is an input to the first attention model 712. An output of the first attention model 712 is an input to the feedforward neural network 714. An output of the feedforward neural network 714 is an output of the encoding layer 71. For example, the natural language processing model 7A comprises a plurality of the encoding layers 71 connected in series. An input to a first encoding layer is the word vector data of the text data, and an output of a last encoding layer is an output of the whole encoding structure formed by the plurality of the encoding layers connected in series. An input to a second encoding layer to the last encoding layer is an output of a previous encoding layer.

In some embodiments, the encoding layer 71 further comprises a first summation and normalization module 713 and a second summation and normalization module 715. The first summation and normalization module 713 and the second summation and normalization module 715 are each configured to perform summation operation and normalization operation on their inputs.

The first summation and normalization module 713 is configured to perform summation operation and normalization operation on the input and output of the first attention model 712. The second summation and normalization module 715 is configured to perform summation operation and normalization operation on the input and output of the feedforward neural network 714.

In some embodiments, the natural language processing model 7A further comprises a decoding layer 72. The output of the encoding layer 71 is an input to the decoding layer 72. An output of the decoding layer 72 is the output information of the natural language processing model 7A. In a case where the natural language processing model 7A comprises a plurality of the encoding layers 71 connected in series, the output of the last encoding layer is the input to the decoding layer 72.

In some embodiments, the decoding layer 72 comprises a neural network model 721. The output of the encoding layer 71 is an input to the neural network model 721. An output of the neural network model 721 is the output information of the natural language processing model 7A. For example, the neural network model 721 is configured to perform a specific natural language processing task. In some embodiments, the neural network model 721 has a fully-connected layer structure.

Based on FIG. 7A, the determining the output information of the natural language processing model according to the output of the first attention model comprises: after the output of the first attention model is sequentially subjected to the first summation and normalization module 713, the feedforward neural network 714 and the second summation and normalization module 715, obtaining the output of the encoding layer 71. The output of the encoding layer 71 is taken as an input to the neural network model 721 in the decoding layer 72, which is processed by the neural network model 721 to obtain the output of the decoding layer 72 as the output information of the natural language processing model.

FIG. 7B is a block diagram illustrating a natural language processing model according to other embodiments of the present disclosure.

As shown in FIG. 7B, a natural language processing model 7B comprises an encoding layer 71, the encoding layer 71 comprising a first attention model 712. The first attention model 712 performs the steps S24 to S27 as shown in FIG. 6. For example, the natural language processing model 7B comprises a plurality of the encoding layers 71 connected in series. An input to a first encoding layer is the word vector data of the text data, and an output of a last encoding layer is an output of the whole encoding structure formed by the plurality of the encoding layers connected in series. An input to a second encoding layer to the last encoding layer is an output of a previous encoding layer.

In some embodiments, the encoding layer 71 further comprises a first feedforward neural network 714. The word vector data of the text data is an input to the first attention model 712. An output of the first attention model 712 is an input to the first feedforward neural network 714. An output of the first feedforward neural network 714 is an output of the encoding layer 71.

In some embodiments, the encoding layer 71 further comprises a first summation and normalization module 713 and a second summation and normalization module 715. The first summation and normalization module 713 and the second summation and normalization module 715 are each configured to perform summation operation and normalization operation on their inputs.

The first summation and normalization module 713 is configured to perform summation operation and normalization operation on the input and output of the first attention model 712. The second summation and normalization module 715 is configured to perform summation operation and normalization operation on the input and output of the feedforward neural network 714.

In some embodiments, the natural language processing model 7B further comprises a decoding layer 72. The output of the encoding layer 71 is an input to the decoding layer 72. An output of the decoding layer 72 is the output information of the natural language processing model 7. In a case where the natural language processing model 7B comprises the plurality of the encoding layers 71 connected in series, the output of the last encoding layer is the input to the decoding layer 72.

In some embodiments, the decoding layer 72 comprises a second attention model 722 and a third attention model 724. An input to the third attention model 724 comprises the output of the encoding layer 71 and an output of the second attention model 722. An output of the third attention model 724 is an output of the decoding layer 72.

In some embodiments, the natural language processing model 7B comprises a plurality of the decoding layers 72 connected in series. Taking an example that the natural language processing model 7B comprises the plurality of the encoding layers 71 connected in series, the output of the last encoding layer 71 is an input to each decoding layer 72, and an output of a last decoding layer 72 is the output information of the natural language processing model 7B. The output of the last encoding layer 71 is an input to a third attention model 724 in each decoding layer 72. An output of each decoding layer other than the last decoding layer is taken as an input to a following decoding layer connected in series.

For example, in the process of natural language processing by using the natural language processing model, an input to the second attention model of the first decoding layer is an output of the last decoding layer, and an input to the second attention model of the second decoding layer to the last decoding layer is an output of a previous decoding layer. The plurality of the decoding layers connected in series further perform processing for each position. When processing other positions before a last position, the output of the last decoding layer is the input to the second attention model of the first decoding layer, and is also an output of the decoding structure formed by the plurality of the decoding layers connected in series for each position. When processing the last position, the output of the last decoding layer is an output of the whole decoding structure for the last position.

For another example, in the process of training the natural language processing model, an input to the second attention model of the first decoding layer is tag data of training data, and an input to the second attention model of the second decoding layer to the last decoding layer is an output of a previous decoding layer. In some embodiments, in a case where the natural language processing model is used for translation from Chinese to English, the training data is Chinese text data and the tag data is English text data which is correct translation of the Chinese text data.

In some embodiments, the first attention model, the second attention model, and the third attention model may all be multi-head attention models. In the multi-head attention model, input data of the multi-head attention model is divided into a plurality of sub-data, and after the plurality of sub-data are inputted into each head of the multi-head attention model for corresponding processing, splicing operation and linear transformation operation are sequentially performed on outputs of the multiple heads to obtain an output of the multi-head attention model.

In some embodiments, the decoding layer 72 further comprises a third summation and normalization module 723, a fourth summation and normalization module 725, a second feedforward neural network 726, and a fifth summation and normalization module 727. The third summation and normalization module 723, the fourth summation and normalization module 725 and the fifth summation and normalization modules 727 are each configured to perform summation operation and normalization operation on their inputs.

For example, the third summation and normalization module 723 is configured to perform summation operation and normalization operation on the input and output of the second attention model 722. An output of the third summation and normalization module 723 is an input to the third attention model 724. The fourth summation and normalization module 725 is configured to perform summation operation and normalization operation on the input and output of the third attention model 724. An output of the fourth summation and normalization module 725 is an input to the second feedforward neural network 726. The fifth summation and normalization module 727 is configured to perform summation operation and normalization operation on the input and output of the second feedforward neural network 726. An output of the fifth summation and normalization module 727 is the output of the decoding layer 72.

In some embodiments, the natural language processing model 7B further comprises a linear transformation module 73. The linear transformation module 73 is configured to perform linear transformation the output of the decoding layer 72.

In some embodiments, the natural language processing model 7B further comprises a normalization module 74. The normalization module 74 is configured to perform normalization operation on an output of the linear transformation module 73 to obtain the output information of the natural J language processing model 7B. For example, the normalization module 74 performs softmax normalization operation on the output of the linear transformation module 73.

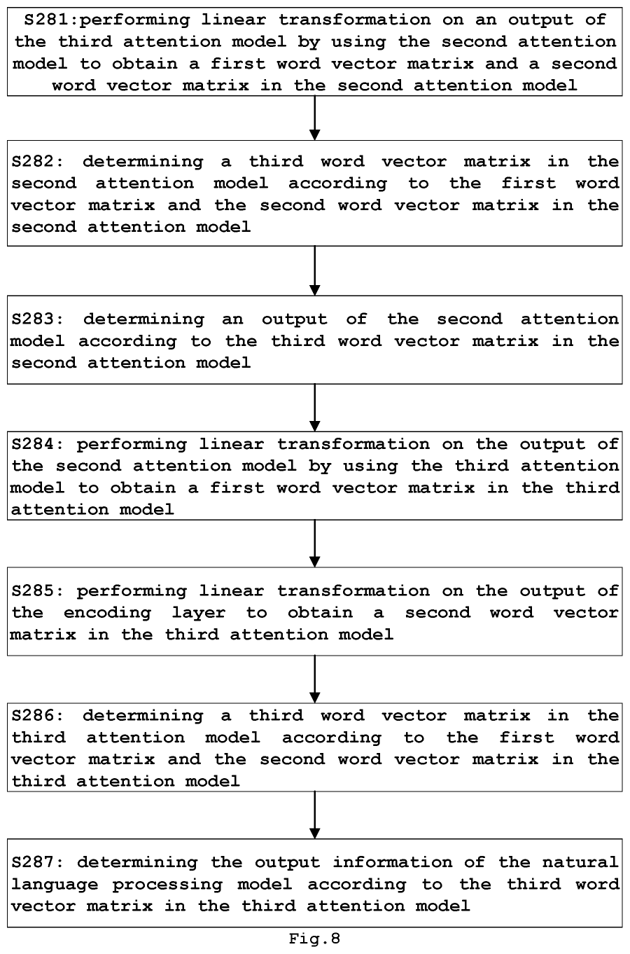

Based on FIG. 7B, taking an example that the decoding layer comprises the second attention model and the third attention model, the above step S28 is described in detail below in conjunction with FIG. 8.

FIG. 8 is a flow diagram illustrating determining output information of a natural language processing model according to an output of a first attention model, according to some embodiments of the present disclosure.

As shown in FIG. 8, the determining output information of a natural language processing model according to an output of a first attention model comprises steps S281 to S287.

In the step S281, linear transformation on an input to the second attention model is performed by using the second attention model to obtain a first word vector matrix and a second word vector matrix in the second attention model. For example, the first word vector matrix and the second word vector matrix in the second attention model are obtained based on different linear transformation of a same word vector. For example, the first word vector matrix is a query vector matrix and the second word vector matrix is a key vector matrix.

Taking an example that the natural language processing model comprises the plurality of the decoding layers connected in series, the input to the second attention model in the process of natural language processing by using the natural language processing model and in the process of training the natural language processing model will be described in detail below.

In the process of natural language processing by using the natural language processing model, an input to the second attention model of the first decoding layer is an output of a last decoding layer, and an input to the second attention model of the second decoding layer to the last decoding layer is an output of a previous decoding layer. In the process of training the natural language processing model, an input to the second attention model of the first decoding layer is tag data of training data, and an input to the second attention model of the second decoding layer to the last decoding layer is an output of a previous decoding layer.

In some embodiments, as shown in FIG. 7B, in a case where the decoding layer 72 comprises the fourth summation and normalization module 725, the second feedforward neural network 726, and the fifth summation and normalization module 727, and the natural language processing model 7B comprises the linear transformation module 73 and the normalization module 74, the second attention model 722 performs linear transformation on the output of the normalization module 74 to obtain the first word vector matrix and the second word vector matrix in the second attention model.

In the step S282, a third word vector matrix in the second attention model is determined according to the first word vector matrix and the second word vector matrix in the second attention model.

In the step S283, an output of the second attention model is determined according to the third word vector matrix in the second attention model.

In some embodiments, scale transformation, alignment operation, sequential masking operation, and normalization operation are sequentially performed on the third word vector matrix in the second attention model to obtain a second attention score matrix. Furthermore, the output of the second attention model is determined according to the second attention score matrix. The second attention score matrix is used for describing an attention weight score of the input to the second attention model.

In the step S284, linear transformation is performed on the output of the second attention model by using the third attention model to obtain a first word vector matrix in the third attention model. For example, the first word vector matrix is a query vector matrix.

In some embodiments, as shown in FIG. 7B, in a case where the decoding layer 72 comprises the third summation and normalization module 723, the third attention model 724 performs linear transformation on the output of the third summation and normalization module 723 to obtain the first word vector matrix in the third attention model.

In the step S285, linear transformation is performed on the output of the encoding layer to obtain a second word vector matrix in the third attention model. For example, the second word vector matrix is a key vector matrix. In some embodiments, the first word vector matrix and the second word vector matrix in the third attention model are obtained based on linear transformation of different words. For example, linear transformation on the output of the encoding layer may also be performed to obtain a fifth word vector matrix, i.e., a value vector matrix.

In some embodiments, as shown in FIG. 7B, in a case where the encoding layer 71 comprises the first summation and normalization module 713, the first feedforward neural network 714, and the second summation and normalization module 715, the third attention model 724 performs linear transformation on the output of the second summation and normalization module 715 to obtain the second word vector matrix in the third attention model.

In the step S286, a third word vector matrix in the third attention model is determined according to the first word vector matrix and the second word vector matrix in the third attention model.

In the step S287, the output information of the natural language processing model is determined according to the third word vector matrix in the third attention model.

In some embodiments, scale transformation, alignment operation and normalization operation are sequentially performed on the third word vector matrix in the third attention model to obtain a third attention score matrix. The output information of the natural language processing model is determined according to the third attention score matrix. The third attention score matrix is used for describing an attention weight score of the input to the third attention model. For example, the output information of the natural language processing model is determined according to a product of the third attention score matrix and the fifth word vector matrix in the third attention model.

Taking FIG. 7B as an example, the third attention score matrix is sequentially subjected to the fourth summation and normalization module 725, the second feedforward neural network 726 and the fifth summation and normalization module 727, to obtain the output of the decoding layer 72. The output of the decoding layer 72 is sequentially subjected to the linear transformation module 73 and the normalization module 74, to obtain the output information of the natural language processing model.

Based on the above embodiment, taking an example that the natural language processing model comprises the encoding layer and the decoding layer, an output of the encoding layer is an input to the decoding layer, and the encoding layer comprises the first attention model. For example, the training the natural language processing model according to the output information of the natural language processing model can be implemented by the following steps (1) to (5).

(1) processing the text data by using the encoding layer to obtain the output of the encoding layer.

(2) inputting the output of the encoding layer into the decoding layer to obtain an output of the decoding layer.

(3) determining the output information of the natural language processing model according to the output of the decoding layer.

(4) determining a loss value of a loss function according to the output information of the natural language processing model. For example, the loss function is a cross-entropy function. For example, the cross-entropy function is L₁(θ)=−Σᵢ₌₁^{M}, log p(m=mᵢ|θ), mᵢ∈[1, 2 . . . , |M|], where θ represents a model parameter. M represents a word set, mᵢ is an ith tag in the word set M, and |M| represents a dictionary size of the word set M. P( ) represents a probability.

(5) training the natural language processing model according to the loss value of the loss function.

For another example, the text data comprises first training text data and second training text data. The training the natural language processing model according to the output information of the natural language processing model can also be implemented by the following steps 1) to 7).

1) processing the first training text data by using the encoding layer to obtain the output of the encoding layer. For example, the first training text data is text data such as Wikipedia, in which use scenarios of data are not distinguished.

2) determining a loss value of a first loss function according to the output of the encoding layer.

3) performing first training on the encoding layer according to the loss value of the first loss function. For example, the first training employs at least one of an LM (Language Modeling) training method, an MLM (Masked Language Modeling) training method, an NSP (Next Sentence Prediction) training method, an SOP (Sentence Order Prediction) training method, or a DAE (De-noising Auto-encoder) training method.

Taking an example that the first training is the MLM training method and the NSP training method, the first loss function may be L₁(θ,θ₁,θ₂)=−Σᵢ₌₁^{M} log p(m=mᵢ|θ,θ₁)−Σᵢ₌₁^{N} log p (n=nᵢ|θ, θ₂), where mᵢ∈[1, 2 . . . , |M|], nᵢ∈[IsNext, NotNext]. θ represents a parameter of the encoding layer, for example, a parameter of an encoder in BERT. θ₁ and θ₂ represent a parameter of an output layer connected to an encoder in an MLM training task and a parameter of a classifier connected to an encoder in an NSP training task, respectively. M represents a word set, mᵢ is an ith tag in the word set M, and |M| represents a dictionary size of the word set M. N represents another word set, nᵢ represents an ith tag in the other word set N, with a value of IsNext or NotNext. IsNext and NotNext respectively represent whether a second sentence in two sentences is a next sentence of a first sentence. P( ) represents a probability.

4) processing the second training text data by using the encoding layer after the first training to obtain an output of the encoding layer after the first training. For example, the second training text data is text data closely related to the natural language processing task of the natural language processing model.

5) inputting the output of the encoding layer after the first training into the decoding layer to obtain the output information of the natural language processing model. In some embodiments, the decoding layer is a fully-connected layer.

6) determining a loss value of a second loss function according: information of the natural language processing model. For example, the second loss function may also be the above cross-entropy function, which will not be repeated here.

7) in a case where the encoding layer after the first training is frozen, performing second training on the decoding layer according to the loss value of the second loss function.

The principle and effect of applying the sequential coding matrix in the natural language processing model of the present disclosure will be further described below in conjunction with a specific example.

For example, text data ABCD and DCBA comprising four words are inputted into the natural language processing model, respectively.

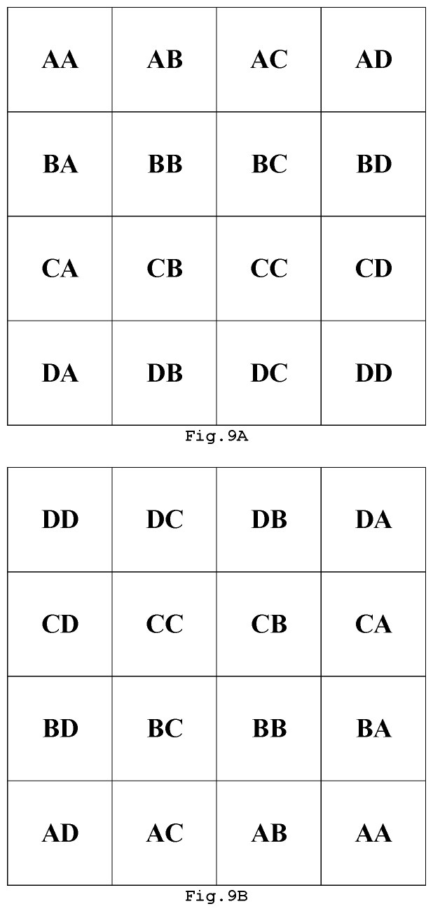

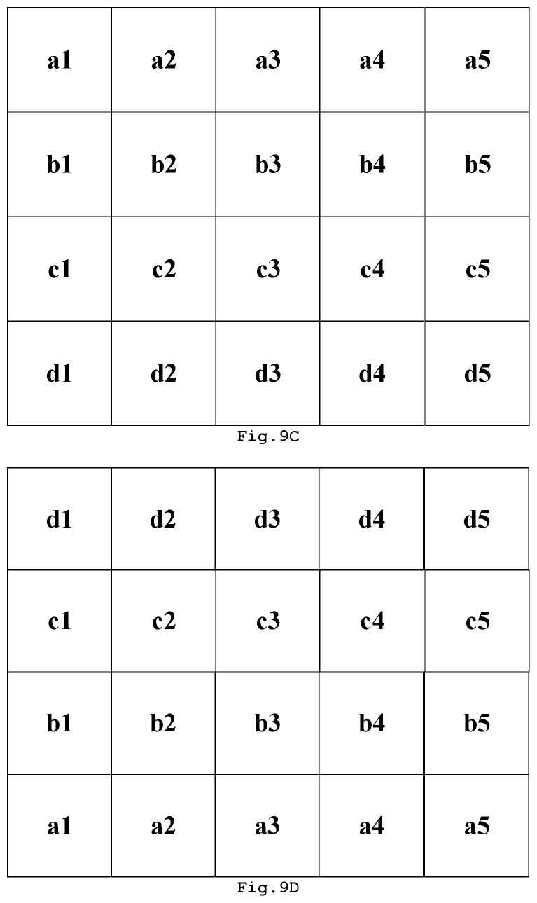

It is assumed that incidence matrices of the text data ABCD and the text data DCBA are represented as structures shown in FIGS. 9A and 9B, respectively. The association matrix is determined by a query vector matrix (a combination of a plurality of query vectors) of the text data and a transpose of a key vector matrix (a combination of a plurality of key vectors).

As shown in FIG. 9A, each grid represents one value of an element, and first to fourth rows represent third word vector matrices of words A, B, C, D, respectively. As shown in FIG. 9B, each grid also represents one value of an element, and first to fourth rows represent third word vector matrices of words D, C, B, A, respectively.

Value vector matrices (combinations of a plurality of value vectors) of the text data ABCD and the text data DCBA are represented as structures shown in FIGS. 9C and 9D, respectively.

A combination of scale transformation, mask operation and normalization operation in the first attention model is represented by using a function S( ).

As shown in FIG. 9C, each grid represents one value of an element, and first to fourth rows represent value vectors of words A, B, C, D, respectively. As shown in FIG. 9D, each grid also represents one value of an element, and first to fourth rows represent value vectors of words D, C, B, A, respectively.

In a case where the sequential coding matrix is not used, after the first attention model processes the association matrix shown in FIG. 9A by using the function S( ) the processing result is multiplied by the value vector matrix shown in FIG. 9C to obtain an output for the text data ABCD.

After the first attention model processes the association matrix shown in FIG. 9B by using the function S( ) the processing result is multiplied by the value vector matrix shown in FIG. 9D to obtain an output for the text data DCBA.

Table 1 shows the outputs of the first attention model for the text data ABCD and DCBA in a case where the sequential coding matrix is not used.

TABLE 1

| | For text data ABCD | For text data DCBA |
|---|---|---|
| For A | S(AA)a1 + S(AB)b1 + S(AC)c1 + S(AD)d1; | S(AD)d1 + S(AC)c1 + S(AB)b1 + S(AA)a1; |
| | S(AA)a2 + S(AB)b2 + S(AC)c2 + S(AD)d2; . . . | S(AD)d2 + S(AC)c2 + S(AB)b2 + S(AA)a2; . . . |
| | S(AA)a5 + S(AB)b5 + S(AC)c5 + S(AD)d5 | S(AD)d5 + S(AC)c5 + S(AB)b5 + S(AA)a5; |
| For B | S(BA)a1 + S(BB)b1 + S(BC)c1 + S(BD)d1; | S(BA)a1 + S(BB)b1 + S(BC)c1 + S(BD)d1; |
| | S(BA)a2 + S(BB)b2 + S(BC)c2 + S(BD)d2; . . . | S(BA)a2 + S(BB)b2 + S(BC)c2 + S(BD)d2; . . . |
| | S(BA)a5 + S(BB)b5 + S(BC)c5 + S(BD)d5 | S(BA)a5 + S(BB)b5 + S(BC)c5 + S(BD)d5 |
| For C | S(CA)a1 + S(CB)b1 + S(CC)c1 + S(CD)d1; | S(CA)a1 + S(CB)b1 + S(CC)c1 + S(CD)d1; |
| | S(CA)a2 + S(CB)b2 + S(CC)c2 + S(CD)d2; . . . | S(CA)a2 + S(CB)b2 + S(CC)c2 + S(CD)d2; . . . |
| | S(CA)a5 + S(CB)b5 + S(CC)c5 + S(CD)d5 | S(CA)a5 + S(CB)b5 + S(CC)c5 + S(CD)d5 |
| For D | S(DA)a1 + S(DB)b1 + S(DC)c1 + S(DD)d1; | S(DA)a1 + S(DB)b1 + S(DC)c1 + S(DD)d1; |
| | S(DA)a2 + S(DB)b2 + S(DC)c2 + S(DD)d2; . . . | S(DA)a2 + S(DB)b2 + S(DC)c2 + S(DD)d2; . . . |
| | S(DA)a5 + S(DB)b5 + S(DC)c5 + S(DD)d5 | S(DA)a5 + S(DB)b5 + S(DC)c5 + S(DD)d5 |

In the table 1, for each word, a plurality of attention scores will be generated, which are separated by semicolons “;”. An ellipsis represents an attention score not presented, which may be calculated in a similar manner to other attention scores. It can be seen through comparison that, in a case where the sequential coding matrix is not used, for same words in text data with different word order, same attention scores will be generated, so that word order and semantic information of the same words in the text data with different word order cannot be distinguished.

In a case where the sequential coding matrix is not used, after the first attention model sequentially processes the association matrix shown in FIG. 9A by using the sequential coding matrix and the function S( ) the processing result is multiplied by the value vector matrix shown in FIG. 9C to obtain an output for the text data ABCD.

After the first attention model sequentially processes the association matrix shown in FIG. 9B by using the sequential coding matrix and the function S( ) the processing result is multiplied by the value vector matrix shown in FIG. 9D to obtain an output for the text data ABCD.

Calculation is performed below by taking an example that the sequential coding matrix is the matrix structure shown in FIG. 2D.

Table 2 shows the outputs of the first attention model for the text data ABCD and DCBA in a case where the sequential coding matrix is used.

TABLE 2

| | For text data ABCD | For text data DCBA |
|---|---|---|
| For A | S(AA)a1 + S(AB)b1 + S(AC)c1 + S(AD)d1; | S(AD)d1 + S(−AC)c1 + S(−AB)b1 + S(−AA)a1; |
| | S(AA)a2 + S(AB)b2 + S(AC)c2 + S(AD)d2; . . . | S(AD)d2 + S(−AC)c2 + S(−AB)b2 + S(−AA)a2; . . . |
| | S(AA)a5 + S(AB)b5 + S(AC)c5 + S(AD)d5 | S(AD)d5 + S(−AC)c5 + S(−AB)b5 + S(−AA)a5; |
| For B | S(−BA)a1 + S(BB)b1 + S(BC)c1 + S(BD)d1; | S(BA)a1 + S(BB)b1 + S(−BC)c1 + S(−BD)d1; |
| | S(−BA)a2 + S(BB)b2 + S(BC)c2 + S(BD)d2; . . . | S(BA)a2 + S(BB)b2 + S(−BC)c2 + S(−BD)d2; . . . |
| | S(−BA)a5 + S(BB)b5 + S(BC)c5 + S(BD)d5 | S(BA)a5 + S(BB)b5 + S(−BC)c5 + S(−BD)d5 |
| For C | S(−CA)a1 + S(−CB)b1 + S(CC)c1 + S(CD)d1; | S(CA)a1 + S(CB)b1 + S(CC)c1 + S(−CD)d1; |
| | S(−CA)a2 + S(−CB)b2 + S(CC)c2 + S(CD)d2; . . . | S(CA)a2 + S(CB)b2 + S(CC)c2 + S(−CD)d2; . . . |
| | S(−CA)a5 + S(−CB)b5 + S(CC)c5 + S(CD)d5 | S(CA)a5 + S(CB)b5 + S(CC)c5 + S(−CD)d5 |
| For D | S(−DA)a1 + S(−DB)b1 + S(−DC)c1 + S(DD)d1; | S(DA)a1 + S(DB)b1 + S(DC)c1 + S(DD)d1; |
| | S(−DA)a2 + S(−DB)b2 + S(−DC)c2 + S(DD)d2; . . . | S(DA)a2 + S(DB)b2 + S(DC)c2 + S(DD)d2; . . . |
| | S(−DA)a5 + S(−DB)b5 + S(−DC)c5 + S(DD)d5 | S(DA)a5 + S(DB)b5 + S(DC)c5 + S(DD)d5 |

In the Table 2, for each word, a plurality of attention scores will be generated, which are separated by semicolons “;”. An ellipsis represents an attention score not presented, which may be calculated in a similar manner to other attention scores. It can be seen through comparison that, in a case where the sequential coding matrix is used, different attention scores will be generated for same words in text data with different word order, so that word order and semantic information of the same words in the text data with different word order can be distinguished, which can improve accuracy of natural language processing compared with the condition that the sequential coding matrix is not used. Experiments show that when training based on a training set such as Wiki (Wikipedia) and BookCorpus, the model embodiments of the present disclosure remarkably improve various evaluation indexes of GLUE, compared with the existing natural language processing model, especially the natural language processing model based on positional encoding.

So far, various method embodiments of the present disclosure have been described in detail, and corresponding product embodiments are described below. An embodiment of the present disclosure further provides an electronic device.

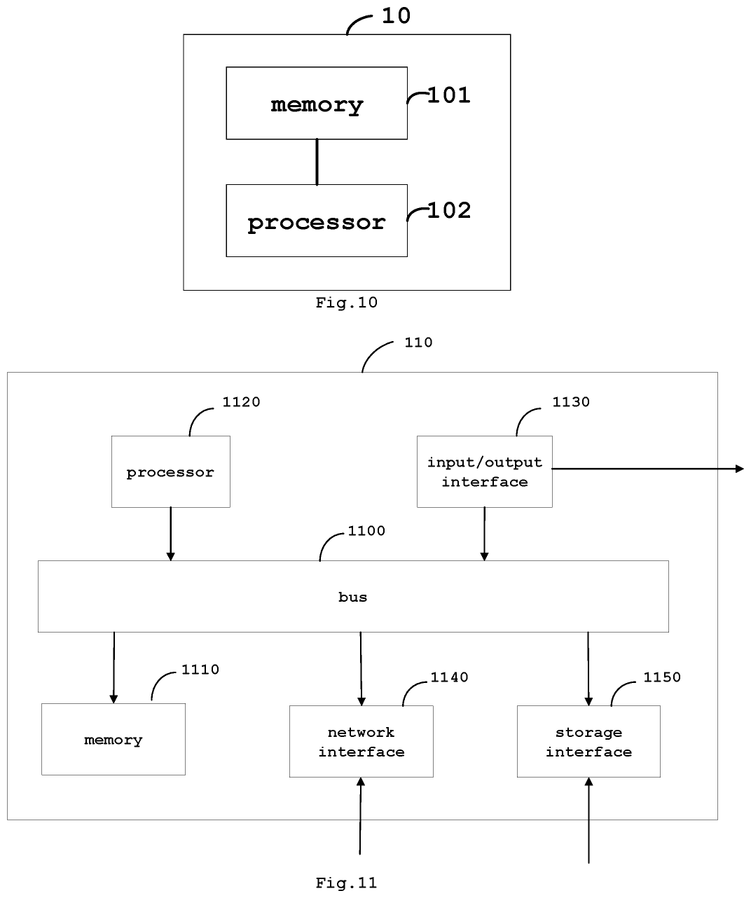

FIG. 10 is a block diagram illustrating an electronic device according to one embodiment of the present disclosure.

As shown in FIG. 10, the electronic device 10 comprises: a memory 101 and a processor 102 coupled to the memory 101. The memory 101 is configured to store instructions of corresponding embodiments performing the method for natural language processing or the method of training a natural language processing model. The processor 102 is configured to perform, based on the instructions stored in the memory 101, one or more steps of the method for natural language processing or the method of training a natural language processing model in any of the embodiments of the present disclosure.

It should be understood that one or more of the steps of the foregoing method for natural language processing or method of training a natural language processing model may be implemented by the processor and may be implemented in any of software, hardware, firmware, or a combination thereof.

In addition to the method for natural language processing or the method of training a natural language processing model, and the electronic device, the embodiments of the present disclosure may take a form of a computer program product implemented on one or more non-volatile storage media containing computer program instructions. Accordingly, the embodiments of the present disclosure further provide a computer-readable storage medium having thereon stored computer instructions which, when executed by a processor, implement one or more steps of the method for natural language processing or the method of training a natural language processing model in any of the foregoing embodiments.

FIG. 11 is a block diagram illustrating a computer system for implementing some embodiments of the present disclosure.

As shown in FIG. 11, the computer system may be represented in a form of a general-purpose computing device, and may be used for implementing the hand-drawn pattern recognition apparatus of the above embodiments. The computer system comprises a memory 1110, a processor 1120, and a bus 1100 connecting different system components.

The memory 1110 may include, for example, a system memory, non-volatile storage medium, and the like. The system memory has thereon stored, for example, an operating system, an application, a boot loader, other programs, and the like. The system memory may include a volatile storage medium, such as a random access memory (RAM) and/or cache memory. The non-volatile storage medium has thereon stored, for example, instructions of corresponding embodiments performing the method according to the present disclosure. The non-volatile storage medium includes, but is not limited to, a magnetic disk memory, optical memory, flash memory, and the like.

The processor 1120 may be implemented by using a general-purpose processor, a digital signal processor (DSP), an application specific integrated circuit (ASIC), a field programmable gate array (FPGA) or other programmable logic devices, discrete hardware components such as a discrete gate or transistor. Accordingly, each device, such as the judgment device and the determination device, may be implemented by running, by a central processing unit (CPU), the instructions in the memory that perform the corresponding steps, or by a dedicated circuit performing the corresponding steps.

The bus 1100 may employ any of a variety of bus architectures. For example, the bus architecture includes, but is not limited to, an industry standard architecture (ISA) bus, a micro channel architecture (MCA) bus, and a peripheral component interconnect (PCI) bus.

The computer system may also comprise an input/output interface 1130, a network interface 1140, a storage interface 1150, and the like. These interfaces 1130, 1140, 1150 and the memory 1110 may be connected with the processor 1120 by the bus 1100. The input/output interface 1130 may provide a connection interface for input/output devices such as a display, a mouse, and a keyboard. The network interface 1140 provides a connection interface for various networking devices. The storage interface 1140 provides a connection interface for external storage devices such as a floppy disk, a USB flash disk, and an SD card.

So far, various embodiments of the present disclosure have been described in detail. Some details well known in the art have not been described in order to avoid obscuring the concepts of the present disclosure. Those skilled in the art can fully appreciate how to implement the technical solutions disclosed herein according to the foregoing description.

Although some specific embodiments of the present disclosure have been described in detail by the examples, it should be understood by those skilled in the art that the above examples are for illustration only and are not intended to limit the scope of the present disclosure. It should be understood by those skilled in the art that the above embodiments can be modified and partial technical features can be equivalently replaced without departing from the scope and spirit of the present disclosure. The scope of the present disclosure is defined by the attached claims.

1. A method for natural language processing, comprising:
acquiring text data; and
processing the text data by using a natural language processing model to obtain output information, wherein the natural language processing model comprises a first attention model, the first attention model comprising a sequential coding matrix for adding, on the basis of the text data, sequential relation information between at least one word and other words in the text data.

2. The method according to claim 16, wherein
the processing the word vector data by using the natural language processing model to obtain the output information, comprises:
performing linear transformation on the word vector data to obtain a first word vector matrix and a second word vector matrix;
determining a third word vector matrix according to the first word vector matrix and the second word vector matrix;
determining a fourth word vector matrix according to the third word vector matrix and a sequential coding matrix for adding, on the basis of the text data, sequential relation information between the at least one word and other words in the text data; and
determining the output information of the natural language processing model according to the fourth word vector matrix.

3. The method according to claim 16, wherein
the processing the word vector data by using the natural language processing model to obtain the output information comprises:
acquiring an association matrix of the word vector data for characterizing incidence relation information between the at least one word and other words in the text data;
determining a sequential association matrix according to the association matrix and a sequential coding matrix for adding, on the basis of the text data, sequential relation information between the at least one word and other words in the text data; and
determining the output information of the natural language processing model according to the sequential association matrix.

4. A method of training a natural language processing model, comprising:
acquiring text data;
processing the text data by using the natural language processing model to obtain output information, the natural language processing model comprising a first attention model, wherein the first attention model comprises a sequential coding matrix for adding, on the basis of the text data, sequential relation information between at least one word and other words in the text data; and
training the natural language processing model according to the output information of the natural language processing model to obtain the trained natural language processing model.

5. The method according to claim 40, wherein
the processing the word vector data by using the natural language processing model to obtain the output information comprises:
performing linear transformation on the word vector data to obtain a first word vector matrix and a second word vector matrix;
determining a third word vector matrix according to the first word vector matrix and the second word vector matrix;
determining a fourth word vector matrix according to the third word vector matrix and a sequential coding matrix for adding, on the basis of the text data, sequential relation information between the at least one word and other words in the text data; and
determining the output information of the natural language processing model according to the fourth word vector matrix; and
training the natural language processing model according to the output information of the natural language processing model to obtain the trained natural language processing model.

6. The method according to claim 40, wherein
the processing the word vector data by using the natural language processing model to obtain the output information comprises:
acquiring an association matrix of the word vector data, for characterizing incidence relation information between the at least one word and other words in the text data;
determining a sequential association matrix according to the association matrix and a sequential coding matrix for adding, on the basis of the text data, sequential relation information between the at least one word and other words in the text data; and
determining the output information of the natural language processing model according to the sequential association matrix; and
training the natural language processing model according to the output information of the natural language processing model to obtain the trained natural language processing model.

7. The method according to claim 1, wherein the sequential coding matrix consists of an upper triangular matrix and a lower triangular matrix, the sequential coding matrix meets at least one of:
the upper triangular matrix is different from the lower triangular matrix, and a value of any element of the sequential coding matrix is not 0;
a value of any element of the upper triangular matrix is different from a value of any element of the lower triangular matrix;
elements of the upper triangular matrix having a same value;
elements of the lower triangular matrix having a same value;
values of the elements of the upper triangular matrix are opposite numbers to values of the elements of the lower triangular matrix;
the elements of the upper triangular matrix and the lower triangular matrix have absolute values of 1; or
a value of an element in the sequential coding matrix is a training parameter of the natural language processing model.

8. (canceled)

9. (canceled)

10. (canceled)

11. (canceled)

12. (canceled)

13. The method according to claim 3, wherein:
the sequential coding matrix has a same matrix structure as the association matrix; and/or
the determining a sequential association matrix according to the association matrix and a sequential coding matrix comprises
determining the sequential association matrix according to a product of the association matrix and the sequential coding matrix.

14. (canceled)

15. The method according to claim 2, wherein;
the determining a fourth word vector matrix according to the third word vector matrix and a sequential coding matrix comprises
determining the fourth word vector matrix by using scale transformation according to the third word vector matrix and the sequential coding matrix; and/or
the first word vector matrix and the second word vector matrix are obtained based on different linear transformation of a same word vector, or the first word vector matrix and the second word vector matrix are obtained based on linear transformation of different word vectors, respectively.

16. The method according to claim 1, wherein the processing the text data by using a natural language processing model to obtain output information comprises:
performing word embedding processing on the at least one word in the text data to obtain word vector data; and
processing the word vector data by using the natural language processing model to obtain the output information.

17. The method according to claim 3, wherein the acquiring an association matrix of the word vector data comprises:
performing linear transformation on the word vector data to obtain a first word vector matrix and a second word vector matrix;
determining a third word vector matrix according to the first word vector matrix and the second word vector matrix; and
determining the association matrix according to the third word vector matrix; and
the determining a sequential association matrix according to the association matrix and a sequential coding matrix comprises:
determining a fourth word vector matrix according to the third word vector matrix and the sequential coding matrix; and
determining the sequential association matrix according to the fourth word vector matrix.

18. The method according to claim 17, wherein the determining a fourth word vector matrix according to the third word vector matrix and the sequential coding matrix comprises:
determining the fourth word vector matrix by using scale transformation according to the third word vector matrix and the sequential coding matrix.

19. The method according to claim 18, wherein:
the determining the fourth word vector matrix by using scale transformation according to the third word vector matrix and the sequential coding matrix comprises
determining a product of the third word vector matrix and the sequential coding matrix, and
determining the fourth word vector matrix by using scale transformation according to the product; and/or
wherein
the determining the fourth word vector matrix by using scale transformation according to the third word vector matrix and the sequential coding matrix comprises performing scale transformation on the third word vector matrix, and determining the fourth word vector matrix according to a product of the third word vector matrix after the transformation and the sequential coding matrix.

20. (canceled)

21. The method according to claim 18, wherein the determining the output information of the natural language processing model according to the sequential association matrix comprises:
sequentially performing alignment operation and normalization operation on the fourth word vector matrix to obtain a first attention score matrix for describing an attention weight scores of word vectors in the word vector data; and
determining the output information of the natural language processing model according to the first attention score matrix.

22. The method according to claim 21, wherein:
the performing linear transformation on the word vector data comprises performing linear transformation on the word vector data to obtain a fifth word vector matrix; and
the determining the output information of the natural language processing model according to the first attention score matrix comprises determining the output information of the natural language processing model according to a product of the first attention score matrix and the fifth word vector matrix.

23. (canceled)

24. The method according to claim 1, wherein the processing the text data by using a natural language processing model to obtain output information of the natural language processing model comprises:
performing word embedding processing on the at least one word in the text data to obtain word vector data;
performing, by using the first attention model, the following operations on the word vector data:
performing linear transformation on the word vector data to obtain a first word vector matrix and a second word vector matrix corresponding to the text data;
determining a third word vector matrix in the first attention model according to the first word vector matrix corresponding to the text data and the second word vector matrix corresponding to the text data;
determining a fourth word vector matrix according to the third word vector matrix corresponding to the text data and a sequential coding matrix for adding, on the basis of the text data, sequential relation information between the at least one word and other words in the text data; and
determining an output of the first attention model according to the fourth word vector matrix; and
determining the output information of the natural language processing model according to the output of the first attention model.

25. The method according to claim 24, wherein the natural language processing model further comprises a feedforward neural network, the word vector data is an input to the first attention model, and the output of the first attention model is an input to the feedforward neural network.

26. The method according to claim 25, wherein the natural language processing model comprises an encoding layer and a decoding layer, the encoding layer comprises the first attention model and the feedforward neural network, an output of the feedforward neural network is an output of the encoding layer, the output of the encoding layer is an input to the decoding layer, and an output of the decoding layer is the output information of the natural language processing model.

27. The method according to claim 26, wherein the natural language processing model meets at least one of:
the decoding layer comprises a second attention model and a third attention model, an input to the third attention model comprises the output of the encoding layer and an output of the second attention model, an output of the third attention model is the output of the decoding layer,
the natural language processing model comprises a plurality of the encoding layers connected in series and a plurality of the decoding layers connected in series, an input to a first encoding layer is the word vector data, an output of a last encoding layer is an input to each decoding layer, and an output of a last decoding layer is the output information of the natural language processing model; or
the decoding layer comprises a neural network model, the output of the encoding layer is an input to the neural network model, an output of the neural network is the output information of the natural language processing model.

28. (canceled)

29. The method according to claim 26, wherein the decoding layer comprises a second attention model and a third attention model, and the determining the output information of the natural language processing model according to the output of the first attention model comprises:
performing linear transformation on an input to the second attention model by using the second attention model to obtain a first word vector matrix and a second word vector matrix in the second attention model;
determining a third word vector matrix in the second attention model according to the first word vector matrix and the second word vector matrix in the second attention model;
determining an output of the second attention model according to the third word vector matrix in the second attention model;
performing linear transformation on the output of the second attention model by using the third attention model to obtain a first word vector matrix in the third attention model;
performing linear transformation on the output of the encoding layer to obtain a second word vector matrix in the third attention model;
determining a third word vector matrix in the third attention model according to the first word vector matrix and the second word vector matrix in the third attention model; and
determining the output information of the natural language processing model according to the third word vector matrix in the third attention model.

30. The method according to claim 29, wherein the determining an output of the second attention model according to the third word vector matrix in the second attention model comprises:
sequentially performing scale transformation, alignment operation, sequential masking operation and normalization operation on the third word vector matrix in the second attention model to obtain a second attention score matrix for describing an attention weight score of the input to the second attention model, and
determining the output of the second attention model according to the second attention score matrix; and/or
wherein
the determining the output information of the natural language processing model according to the third word vector matrix in the third attention model comprises:
sequentially performing scale transformation, alignment operation and normalization operation on the third word vector matrix in the third attention model to obtain a third attention score matrix for describing an attention weight score of the input to the third attention model, and
determining the output information of the natural language processing model according to the third attention score matrix; and/or
wherein
the first word vector matrix and the second word vector matrix in the first attention model are obtained based on different linear transformation of a same word vector,
the first word vector matrix and the second word vector matrix in the second attention model are obtained based on different linear transformation of a same word vector, and
the first word vector matrix and the second word vector matrix in the third attention model are obtained based on linear transformation of different word vectors.

31. (canceled)

32. (canceled)

33. (canceled)

34. The method according to claim 4, wherein the natural language processing model comprises an encoding layer and a decoding layer, an output of the encoding layer is an input to the decoding layer, the encoding layer comprises the first attention model, and the training the natural language processing model according to the output information of the natural language processing model comprises:
processing the text data by using the encoding layer to obtain the output of the encoding layer;
inputting the output of the encoding layer into the decoding layer to obtain an output of the decoding layer;
determining the output information of the natural language processing model according to the output of the decoding layer;
determining a loss value of a loss function according to the output information; and
training the natural language processing model according to the loss value of the loss function.

35. The method according to claim 4, wherein the text data comprises first training text data and second training text data, the natural language processing model comprises an encoding layer and a decoding layer, an output of the encoding layer is an input to the decoding layer, the encoding layer comprises the first attention model, and the training the natural language processing model according to the output information of the natural language processing model comprises:
processing the first training text data by using the encoding layer to obtain the output of the encoding layer;
determining a loss value of a first loss function according to the output of the encoding layer;
performing first training on the encoding layer according to the loss value of the first loss function;
processing the second training text data by using the encoding layer after the first training to obtain an output of the encoding layer after the first training;
inputting the output of the encoding layer after the first training into the decoding layer to obtain the output information of the natural language processing model;
determining a loss value of a second loss function according to the output information of the natural language processing model; and
in a case where the encoding layer after the first training is frozen, performing second training on the decoding layer according to the loss value of the second loss function.

36. The method according to claim 1, wherein:
the natural language processing model is a natural language generation-class model or a natural language understanding-class model; and/or
the output information is at least one of:
translation information of the text data, reply information of the text data, classification information of the text data, or incidence relation information between the text data and other reference text data.

37. (canceled)

38. An electronic device, comprising:
a memory; and
a processor coupled to the memory, the processor being configured to perform, based on instructions stored in the memory, the method according to claim 1.

39. A non-transitory computer-readable storage medium having thereon stored computer program instructions which, when executed by a processor, implement a method comprising:
acquiring text data; and
processing the text data by using a natural language processing model to obtain output information, wherein the natural language processing model comprises a first attention model, the first attention model comprising a sequential coding matrix for adding, on the basis of the text data, sequential relation information between at least one word and other words in the text data.

40. The method according to claim 4, wherein the processing the text data by using a natural language processing model to obtain output information comprises:
performing word embedding processing on the at least one word in the text data to obtain word vector data; and
processing the word vector data by using the natural language processing model to obtain the output information.
